(19) United States
(12) Patent Application Publication
(10) Pub. No.: US 2022/0150125 A1
(43) Pub. Date: May 12, 2022

(54) AI Named Function Infrastructure and Methods

(71) Applicant: Intel Corporation, Santa Clara, CA (US)

(72) Inventors: Karthik Kumar, Chandler, AZ (US); Francesc Guim Bernat, Barcelona (ES); Marcos Carranza, Portland, OR (US); Rita Wouhaybi, Portland, OR (US); Srikathyayani Srikanteswara, Portland, OR (US)

(21) Appl. No.: 17/559,915

(22) Filed: Dec. 22, 2021

(51) Int. Cl. H04L 41/12; G06N 20/00; H04L 41/14

(52) U.S. Cl. CPC H04L 41/12; H04L 41/145; G06N 20/00

(57) ABSTRACT

Methods, apparatus, systems, and articles of manufacture to manage an edge infrastructure including a plurality of artificial intelligence models are disclosed. An example edge infrastructure apparatus includes a model data structure to identify a plurality of models and associated meta-data from a plurality of circuitry connectable via the edge infrastructure apparatus. The example apparatus includes model inventory circuitry to manage the model data structure to at least one of query for one or more models, add a model, update a model, or remove a model from the model data structure. The example apparatus includes model discovery circuitry to select at least one selected model of the plurality of models identified in the model data structure in response to a query. The example apparatus includes execution logic circuitry to inference the selected model.

### FIELD OF THE DISCLOSURE

This disclosure relates generally to artificial intelligence infrastructure, and, more particularly, to artificial intelligence named function infrastructure and associated methods.

### BACKGROUND

Edge computing is emerging as a platform for ultra-low latency access to compute resources for a large emerging class of applications. However, current edge computing configurations lack an infrastructure to manage applications and access to compute resources. Additionally, cross-edge information, communication, and management is limited or even unavailable in current edge computing platforms. As such, there is a need for improved, cross-edge resource and application management.

### BRIEF DESCRIPTION OF THE DRAWINGS

FIG. 1 illustrates an example cloud-edge architecture or infrastructure.

FIG. 2 shows another example edge-based computing infrastructure.

FIG. 3 illustrates another example edge-based computing infrastructure.

FIG. 4 illustrates an example configuration of the example edge computing infrastructure of FIG. 3.

FIG. 5 illustrates an example implementation of the edge computing infrastructure of FIG. 4.

FIG. 6 illustrates an example implementation of the logic circuitry of FIGS. 4-5.

FIGS. 7-9 are flow charts representative of example machine-readable instructions that can be executed to implement all or part of the example infrastructure of FIGS. 1-6.

FIGS. 10-12 are block diagrams of example processor platforms structured to execute the instructions of FIGS. 7-9 to implement the example edge computing infrastructure apparatus of FIGS. 1-6.

FIG. 13 illustrates an overview of an edge cloud configuration for edge computing.

FIG. 14 illustrates operational layers among endpoints, an edge cloud, and cloud computing environments.

FIG. 15 illustrates an example approach for networking and services in an edge computing system.

FIG. 16 illustrates deployment of a virtual edge configuration in an edge computing system operated among multiple edge nodes and multiple tenants.

FIG. 17 illustrates various compute arrangements deploying containers in an edge computing system.

FIG. 18 illustrates a compute and communication use case involving mobile access to applications in an edge computing system.

FIG. 19 illustrates an example mobile edge system reference architecture, arranged according to an ETSI Multi-Access Edge Computing (MEC) specification.

FIG. 20A provides an overview of example components for compute deployed at a compute node in an edge computing system.

FIG. 20B provides a further overview of example components within a computing device in an edge computing system.

FIG. 21 illustrates a domain topology for respective internet-of-things (IoT) networks coupled through links to respective gateways, according to an example.

FIG. 22 illustrates a cloud computing network in communication with a mesh network of IoT devices operating as a fog device at the edge of the cloud computing network, according to an example.

FIG. 23 illustrates a drawing of a cloud computing network, or cloud, in communication with a number of Internet of Things (IoT) devices, according to an example.

FIG. 24 illustrates a block diagram for an example IoT processing system architecture upon which any one or more of the techniques (e.g., operations, processes, methods, and methodologies) discussed herein may be performed, according to an example.

FIG. 25 illustrates an overview of layers of distributed compute deployed among an edge computing system, according to an example.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

### DETAILED DESCRIPTION

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

Edge computing use cases in mobile network settings have been developed for integration with Multi-access Edge Computing (MEC) approaches, also known as “mobile edge computing.” MEC approaches are designed to allow application developers and content providers to access computing capabilities and an information technology (IT) service environment in dynamic mobile network settings at the edge of the network. Limited standards have been developed by the European Telecommunications Standards Institute (ETSI) industry specification group (ISG) in an attempt to define common interfaces for operation of MEC systems, platforms, hosts, services, and applications.

Edge computing, satellite edge computing (e.g., edge nodes connected to the Internet via satellite), MEC, and related technologies attempt to provide reduced latency, increased responsiveness, and more available computing power than offered in traditional cloud network services and wide area network connections. However, the integration of mobility and dynamically launched services to some mobile use and device processing use cases has led to limitations and concerns with orchestration, functional coordination, and resource management, especially in complex mobility settings where many participants (e.g., devices, hosts, tenants, service providers, operators, etc.) are involved.

In a similar manner, Internet of Things (IoT) networks and devices are designed to offer a distributed compute arrangement from a variety of endpoints. IoT devices can be physical or virtualized objects that may communicate on a network, and can include sensors, actuators, and other input/output components, which may be used to collect data or perform actions in a real-world environment. For example, IoT devices can include low-powered endpoint devices that are embedded or attached to everyday things, such as buildings, vehicles, packages, etc., to provide an additional level of artificial sensory perception of those things. IoT devices have become more popular and thus applications using these devices have proliferated.

In some examples, an edge environment can include an enterprise edge in which communication with and/or communication within the enterprise edge can be facilitated via wireless and/or wired connectivity. The deployment of various Edge, Fog, MEC, and IoT networks, devices, and services have introduced a number of advanced use cases and scenarios occurring at and towards the edge of the network. However, these advanced use cases have also introduced a number of corresponding technical challenges relating to security, processing and network resources, service availability and efficiency, among many other issues. One such challenge is in relation to Edge, Fog, MEC, and IoT networks, devices, and services executing workloads on behalf of endpoint devices including establishing provenance to determine data integrity and/or data restrictions.

The present techniques and configurations may be utilized in connection with many aspects of current networking systems, but are provided with reference to Edge Cloud, IoT, MEC, and other distributed computing deployments. The following systems and techniques may be implemented in, or augment, a variety of distributed, virtualized, or managed edge computing systems. These include environments in which network services are implemented or managed using MEC, fourth generation (4G) or fifth generation (5G) wireless network configurations; or in wired network configurations involving fiber, copper, and/or other connections. Further, aspects of processing by the respective computing components may involve computational elements which are in geographical proximity of user equipment or other endpoint locations, such as a smartphone, vehicular communication component, IoT device, etc. Further, the presently disclosed techniques may relate to other Edge/MEC/IoT network communication standards and configurations, and other intermediate processing entities and architectures.

Edge computing is a developing paradigm where computing is performed at or closer to the “edge” of a network, typically through the use of a computing platform implemented at base stations, gateways, network routers, or other devices which are much closer to end point devices producing and consuming the data. For example, edge gateway servers may be equipped with pools of memory and storage resources (e.g., memory circuitry) to perform computations in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. As another example, central office network management hardware may be replaced with computing hardware that performs virtualized network functions and offers compute resources for the execution of services and consumer functions for connected devices.

Edge environments include networks and/or portions of networks that are located between a cloud environment and an endpoint environment. Edge environments enable computations of workloads at edges of a network. For example, an endpoint device (e.g., a user device) may request a nearby base station to compute a workload rather than a central server in a cloud environment. Edge environments include edge services (e.g., an edge platform for hire (EPH)), which include pools of memory, storage resources, and processing resources. In some examples, edge environments may include an edge as a service (EaaS), which may include one or more edge services. Edge services perform computations, such as an execution of a workload, on behalf of other edge services, edge nodes (e.g., EPH nodes), endpoint devices, etc. Edge environments facilitate connections between producers (e.g., workload executors, edge services) and consumers (e.g., other edge services, endpoint devices).

Because edge services may be closer in proximity to endpoint devices than centralized servers in cloud environments, edge services enable computations of workloads with a lower latency (e.g., response time) than cloud environments. Edge services may also enable a localized execution of a workload based on geographic locations or network topographies. For example, an endpoint device may require a workload to be executed in a first geographic area, but a centralized server may be located in a second geographic area. The endpoint device can request a workload execution by an edge service located in the first geographic area to comply with corporate or regulatory restrictions.

Examples of workloads to be executed in an edge environment (e.g., via an EaaS, via an edge service, on an EPH node, etc.) include autonomous driving computations, video surveillance monitoring, machine learning model executions, and real time data analytics. Additional examples of workloads include delivering and/or encoding media streams, measuring advertisement impression rates, object detection in media streams, speech analytics, asset and/or inventory management, and augmented reality processing.

In some examples, edge services enable both the execution of workloads and a return of a result of an executed workload to endpoint devices with a response time lower than the response time of a server in a cloud environment. For example, if an edge service is located closer to an endpoint device on a network than a cloud server, the edge service may respond to workload execution requests from the endpoint device faster than the cloud server. An endpoint device may request an execution of a time-constrained workload from an edge service rather than a cloud server.

In addition, edge services enable the distribution and decentralization of workload executions. For example, an endpoint device may request a first workload execution and a second workload execution. In some examples, a cloud server may respond to both workload execution requests. With an edge environment, however, a first edge service may execute the first workload execution request, and a second edge service may execute the second workload execution request.

Additional infrastructure may be included in an edge environment to facilitate the execution of workloads on behalf of endpoint devices. For example, an orchestrator may access a request to execute a workload from an endpoint device and provide offers to a plurality of edge nodes. The offers may include a description of the workload to be executed and terms regarding energy and resource constraints. An edge node (e.g., an EPH node) may accept the offer, execute the workload, and provide a result of the execution to infrastructure in the edge environment and/or to the endpoint device.

Delivery of services in an Edge as a Service (EaaS) ecosystem (e.g., in an edge environment, via an EPH, via an edge infrastructure element, etc.) may include a business model where subscribers to the EaaS service (e.g., endpoint devices, user devices, etc.) pay for access to edge services. In some examples, the endpoint devices may pay for edge services (such as an execution of a workload) via micro-payments, credits, tokens, e-currencies, etc. In some examples, revenue models may include mobile network operators (MNOs) that maintain subscriptions from a subscriber base (such as one or more networks) as a way to pay for edge services by entering into service-level agreement (SLA) contracts. An SLA can include one or more service level objectives (SLOs), for example. An SLO can include a metric such as uptime, response time, etc. In certain examples, SLA correspond to resources used to achieve a type of SLO. For example, SLA specifies a number of cores, memory bandwidth, etc., to achieve an SLO of 30 frames per second of an artificial intelligence model, etc. Accounting executed and/or managed by the MNO may determine billable services that are then applied to subscriber accounts.

In certain examples, a single resource or entity can negotiate and manage multiple SLA in an edge environment while managing its resources using one or more SLOs. A SLO is based in an edge cloud environment, for example. The SLO can be instantiated inside a service. The SLA is instantiated within an associated resource. Multiple SLA may compete for particular resources. In certain examples, SLAs can be grouped with an associated level of trust. Grouping of SLAs can be dynamic, based on requirement, trust, user/device type, etc. A group key can be associated with the SLAs, for example. In certain examples, different tenants, entities, resources, and/or other actors can work together to drive one or more SLOs, SLAs, etc.

The rapid growth of edge computing and associated IoT technology presents a challenge and an opportunity for trusted integration and/or interconnection of proprietary technologies, instructions, and/or data. Problems can be further complicated at the edge of the network, where the computing infrastructure is heterogeneous, different systems are maintained in different locations and subject to different failure profiles, timing anomalies are more likely due to non-uniform communication and non-localized placements, and other obfuscating factors, such as power-constrained and bandwidth-constrained distribution of tasks, exist. Adding to these complications is the problem that different edge locations can belong to different trust boundaries. As such, a chain of actions that spans different microservices in loosely-coupled interactions can also be transparent, semi-transparent, or opaque with respect to execution of software, for example. As used herein, the terms “microservice, “service”, “task”, “operation”, and “function” can be used interchangeably to indicate an application, a process, and/or other software code (also referred to as program code) for execution using computing infrastructure, such as an edge computing and/or other IoT environment.

Examples disclosed herein provide a compute infrastructure arranged with respect to one or more resource-constrained environments (e.g., base stations, central offices, etc.). Edge computing infrastructure (also referred to herein as edge infrastructure), taken alone or in combination with a cloud infrastructure, enables and supports a variety of applications and/or use cases, such as autonomous vehicles, drones, robotics, smart city cameras, etc. While an example cloud infrastructure has a latency of at least one hundred milliseconds (100+ ms), an example edge infrastructure provides lower latency (e.g., a few ms, etc.) and offers support for acceleration, training, inferencing, etc.

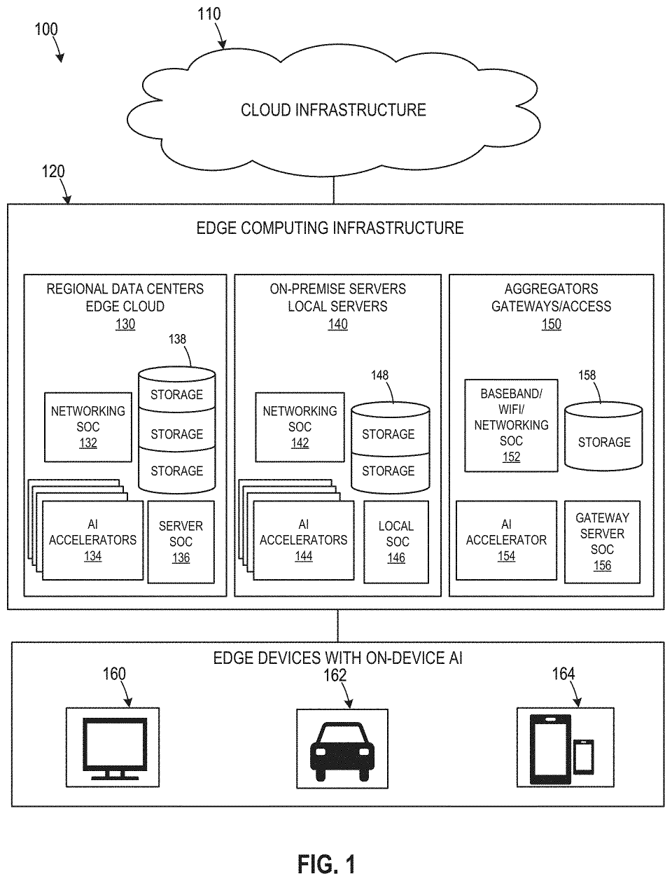

FIG. 1 illustrates an example cloud-edge architecture 100 including an example cloud infrastructure 110 and an example edge infrastructure 120 in communication with one or more edge devices 130 (e.g., including on-device artificial intelligence (AI) models, etc.). AI algorithms can be deployed as models across the edge infrastructure 120, for example. AI models are loaded into memory (e.g., dynamic random-access memory (DRAM), RAM, etc.), programmed into circuitry such as a field-programmable gate array (FPGA), etc., and/or otherwise made available for use on the edge infrastructure 120.

In the example of FIG. 1, the edge computing infrastructure 120 includes a regional data center 130, an on-premise server 140, and an aggregator gateway 150. Different latency and different capabilities are associated with each of the edge computing infrastructure 130-150. For example, the regional data center 130 forms an edge cloud with a latency of 5-10 ms and includes a networking system-on-a-chip (SOC) 132, one or more AI accelerators 134 providing 128-512 trillion operations per second (TOPS), a server SOC 136 operating at approximately 100 Watts (˜100 W), and storage 138. The example on-premise server 140 is a local server with a latency of 1-5 ms and includes a networking SOC 142, one or more AI accelerators 144 providing 64-128 TOPS, a server SOC 146 operating ˜65 W, and storage 148, for example. The example aggregator 150 forms a gateway and/or access point with a latency of 10 microseconds (us) to 1 ms and includes a networking SOC 152, one or more AI accelerators 154 providing 16-64 TOPS, a gateway server SOC 156 operating at less than 30 W, and storage 158, for example.

As shown in the example of FIG. 1, one or more edge devices 160-164 are connected to the edge infrastructure 120. For example, a television or other display 160 (e.g., 10-20 TOPS at less than 10 W, etc.) can be connected to the example edge infrastructure 120. An example vehicle 162 (e.g., 30+ TOPS at less than 20 W, etc.) can be connected to the example edge infrastructure 120. An example mobile device (e.g., phone, tablet, etc.) 164 (e.g., 4-20 TOPS at less than 5 W, etc.) can be connected to the example edge infrastructure 120.

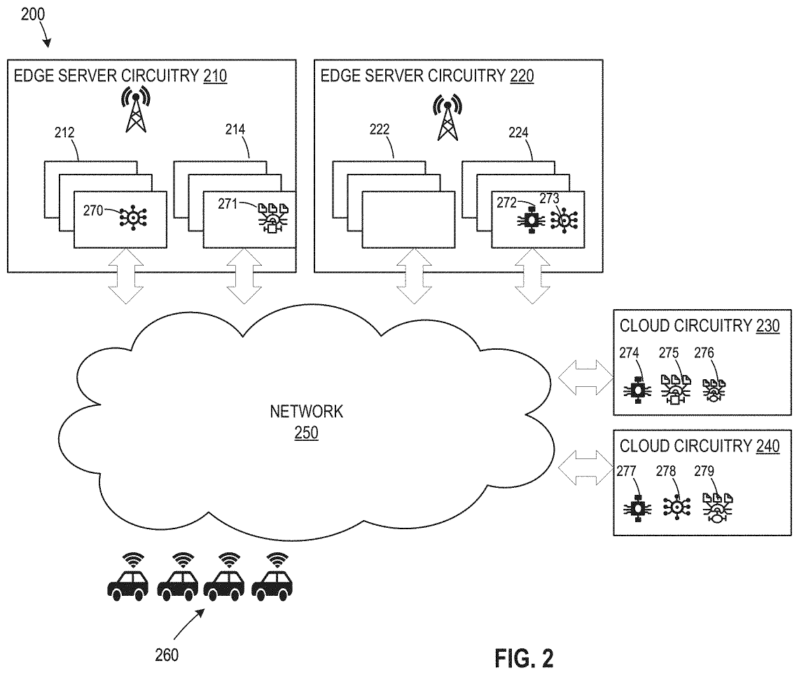

FIG. 2 shows another example infrastructure 200 including a plurality of edge server circuitry 210-220 (also referred to herein as edge server apparatus), such as servers 130-150, etc., interacting with a plurality of cloud infrastructure circuitry 230-240 via a network 250. End devices 260, such as vehicles, etc., can leverage edge server circuitry 210-230 and/or cloud circuitry 230-240 capabilities via the network 250. The example edge server circuitry 210-220 include one or more processor circuitry (e.g., central processing units (CPUs), etc.) 212, 222 and accelerator circuitry 214, 224 (e.g., general processing units (GPUs), field programmable gate arrays (FPGAs), application specific integrated circuits (ASICs), smart network interface cards (NICs), etc.). The cloud platform circuitry 230-240 can also include one or more processors, accelerators, memory, etc.

One or more of the processor circuitry 212, 222 and/or accelerator circuitry 214, 224 can store one or more AI models 270-273. One or more AI models 274-279 can also be available in the cloud circuitry 230-240. However, the AI models 270-279 must be loaded into memory and prepared for the accelerator circuitry 214, 224. For example, a model 270-279 can be loaded into a GPU, programmed into an FPGA, stored in memory (e.g., DRAM, etc.), etc. Preparing and loading a model for an end device 260 can be a time-intensive process. As such, it would be beneficial to map one or more AI models 270-279 onto parts of the infrastructure circuitry 210-240 that is ready with the respective model(s) 270-279. However, current edge infrastructures 210, 220 are unable to track and maintain AI models 270-279 and associated mappings.

Certain examples provide an improved infrastructure for AI model processing, mapping, storage, and deployed. For example, the edge server circuitry 210-220 can determine which model(s) 270-279 to cache for reuse. The example edge server circuitry 210-220 can determine how to evolve models 270-279 included in the edge infrastructure formed by the example edge server circuitry 210-220, for example. End user edge devices 260 can leverage the infrastructure to determine which AI models 270-279 are already available on the edge server circuitry 210-220 and/or the cloud platform circuitry 230-240. End devices 260 can also determine current wait times to utilize AI model(s) 270-279 on the platforms 210-240 on which the model(s) 270-279 are available.

As such, certain examples improve the edge computing infrastructure by providing an ability to query and identify which AI models 270-279 are already available on which edge server circuitry 210-220 and/or cloud server circuitry 230-240. Certain examples improve the edge computing infrastructure by determining a loaded on device queues in the edge server circuitry 210-220. For example, a model may be loaded in an FPGA on one of the edge server circuitry 210-220, but, if there are ten users ahead in the queue to use the same AI model 270-279, the wait time may indicate that the model 270-279 on that server circuitry 210-220 is not a good choice of resource/server. A lack of information regarding wait time can defeat the purpose of using the edge infrastructure.

Additionally, certain examples improve the edge computing infrastructure by enabling a determine of how the AI models 270-279 are being used across the edge 210-220 and cloud 230-240 server infrastructure circuitry. Such model utilization can imply which model(s) 270-279 should be reused/prioritized to cache in memory, remain in FPGA logic, etc. As more end devices 260 contribute to a model 270-279, certain examples identify which model(s) 270-279 should be evolved and maintained, for example.

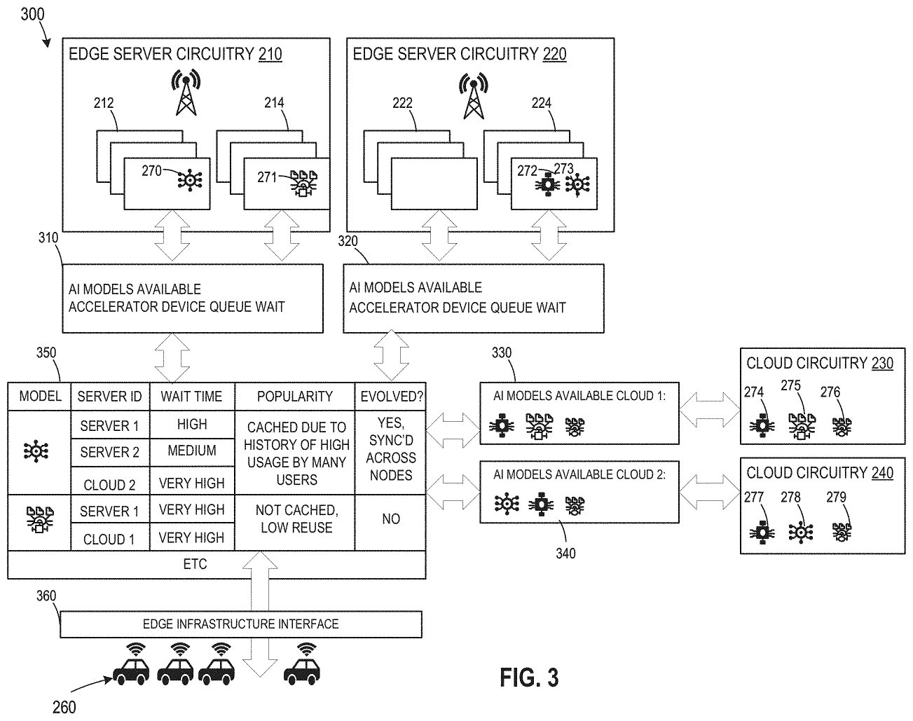

FIG. 3 illustrates another example infrastructure 300, which improves upon the example infrastructure 200 to solve the problems and provide the technical improvements described above. In the example infrastructure 300 of FIG. 3, the edge server circuitry 210-220 and the cloud circuitry 230-240 communicate via interface circuitry 310-340, respectively, which provide an indication of available AI models 270-279 and accelerator queue wait/latency for the respective edge and/or cloud circuitry 210-240. Such information (e.g., model availability, accelerator latency, etc.) is provided by the edge server circuitry 210-220 and the cloud circuitry 230-240 via their respective interface 310-340 to a tablet or other data store 350. The example table 350 can store information for one or more AI models 270-279 such as associated computing device (e.g., edge server circuitry 210-220, cloud circuitry 230-240, etc.), wait time, popularity, evolution status, etc.

As shown in the example of FIG. 3, a first type of AI model 270, 273, 278 is found at the edge server circuitry 210, the edge server circuitry 220, and the cloud circuitry 240. Each of those devices has a different degree or level of wait time (e.g., high, medium, very high, etc.) associated with access to the AI model 270, 273, 278. As indicated in the example table 350, this AI model 270, 273, 278 is cached due to a history of high usage by many users. The example table 350 also indicates that the AI model 270, 273, 278 has evolved as the model 270, 273, 278 has been synchronized across multiple nodes. This information is gathered from the edge server circuitry 210-220 and cloud circuitry 240 storing the AI model 270, 273, 278. Similarly, a second type of AI model 271, 274 can be found on the edge server circuitry 210 and the cloud circuitry 230, both with very high wait time. Due to low reuse, the example table 350 indicates that this AI model 271, 274 is not cached due to low or infrequent reuse and is not evolved.

The plurality of end user devices 260 can access the table 350 via an edge infrastructure interface circuitry 360. The edge infrastructure interface circuitry 360 can be a machine-to-machine interface and/or a user interface, for example. The example interface circuitry 360 allows a device 260 to access and query the table 350 to identify an AI model and determine a location from which to access that AI model. Information, such as wait time, cached/not cached, evolved/not evolved, etc., can factor into selecting a source 210-240 for a particular AI model 270-279, where that model is located at multiple sources. Such information can be referred to as “cost”, and a requesting device 260 can evaluate costs associated with different sources 210-240 of an AI model 270-279 to determine from which source 210-240 to select and utilize the model 270-279, for example.

As such, telemetry (e.g., network telemetry, edge appliance telemetry, etc.) can be provided via the interface circuitry 310-340 to sample device queues and estimate wait times across the infrastructure 300 for one or more AI models 270-279. The telemetry information can be represented as options in the table 350, to end devices 260. The table 350 can be used to specify costs as one option, for various model/infrastructure choices. Further, usage of models 270-279 can be aggregated across all users 260 and used by the edge circuitry 210-220 to make decisions as to which models 270-279 to cache or prioritize for FPGA real estate, for example, as well as which models 270-279 to evolve, maintain, and propagate across the infrastructure 300, for example.

In certain examples, the table 350 can identify which models 270-279 are proprietary and, therefore, limited to use by certain users 260. In some examples, one or more models 270-279 may be hybrid models with certain public or general attribute(s), layer(s), etc., accessible to all users 260 and certain proprietary attribute(s), layer(s), etc., only accessible to certain users 260 (e.g., with a certain ownership, authorization, security level, etc.).

Certain examples provide information-centric networking (ICN) to facilitate and abstract or mask AI inferencing for edge applications with a function-as-a-service model. That is, inferencing or execution of AI models can be hidden, masked, or abstracted as a function call by the edge application to an edge appliance (e.g., an edge server, other edge device, etc.). Using an ICN communication model, content names, rather than network node location addresses (e.g., Internet Protocol (IP) addresses, etc.), are using for identification and communication, for example. Certain examples provide an infrastructure, such as the example infrastructure 300, to name models 270-279 for training, including mutation and self-evolution of one or more of the models 270-279. In certain examples, the edge computing infrastructure 300 caches the named models 270-279 (e.g., in the table 350) and associated information for evaluation, selection, etc.

Certain examples enable edge devices or appliances (e.g., the example edge service circuitry 210-220, etc.) to provide named annotated AI model inferencing (e.g., with an associated confidence level or score in the result or other output). The example infrastructure 300 uses output of the inferences to search for instances of the models with different properties. As such, the example infrastructure 300 manages an inventory for various AI instances of a plurality of AI named models (e.g., models 270-279) that are hosted in various appliances (e.g., the edge server circuitry 210-220, the cloud circuitry 230-240, etc.) that belong to the edge infrastructure 300. Each named model instance (e.g., a speech to text neural network (NN), etc.) has a set of meta-data fields that defines characteristics of the model instance (e.g. accuracy, latency etc.). In some examples, the edge infrastructure 300 includes a cache of AI named instances that may not currently be available in any edge appliance but that have been generated during a lifetime of the example edge infrastructure 300.

In certain examples, as described further below, the edge infrastructure 300 is configured as an AI-named function (AI-NF) infrastructure. An AI-NF infrastructure organizes AI models according to name. Names for AI models, as well as particular instances of AI or AI-NF models, can be determined in a variety of ways. For example, metadata associated with a model can be used by another AI model (e.g., treated as a dataset with x datapoints, y labels, and associated categories) to train the AI model to derive names for particular AI models.

Example edge services can trigger AI-NF logic hosted on the infrastructure to execute an AI-NF model with a set of requirements or parameters (e.g., accuracy, latency, etc.). The AI-NF logic can discover and identify one or more AI-NF model instances based on an associated name and/or other identifier (e.g., according to an ICN mechanism, ICN-like mechanism, hybrid ICN mechanism, a transmission control protocol (TCP) mechanism, using other data communication construct, etc.). The AI-NF logic translates the requirements/parameters into a determination of which available AI model instance is suited (e.g., best suited, better suited, etc.) for the particular request. The AI-NF infrastructure can execute the determined/selected AI model instance in an associated edge appliance (e.g., the edge server circuitry 210, 220, the cloud circuitry 230, 240, etc.), for example. The AI-NF infrastructure can alternatively or additional provide an AI model implementation that satisfies the provided requirements/parameters and that can run on a requestor edge appliance. Selection of an appropriate edge appliance can be based on processing of information such as infrastructure (e.g., network, edge appliance, etc.) telemetry data (e.g., latency, utilization, input/output load, bandwidth, number of open connections, availability, etc.).

In certain examples, edge appliances can provide annotated inferences to the AI-NF infrastructure along with a corresponding confidence score/level/indicator forming one or more named, annotated data sets. The AI-NF infrastructure uses the named, annotated data sets (e.g., per domain, per type of model, etc.) to evaluate variants of AI model topologies to discover new models with new properties. For example, NN topologies can be evaluated for changing size of layers, introducing more convolutional (CONV) layers, etc. Once new models are discovered, the new models can be announced to the edge appliances and/or stored locally, for example.

In certain examples, each named AI model instance can be tagged with other data that can be used to manage processes, rules, etc., such as general data protection regulation (GDPR), data sovereignty, proprietary ownership, restricted access/security, etc., that can be used for the AI-NF infrastructure to decide which AI model instance(s) can be used and where such AI model instance(s) can be used. Certain examples add contextual information so that the AI-NF infrastructure can apply automatic policies to evaluate and use AI model instances.

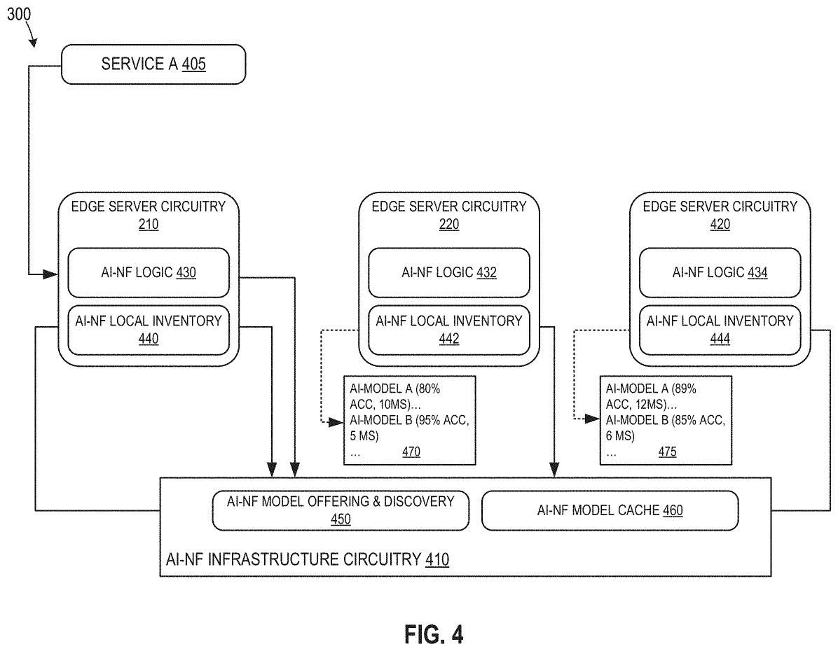

FIG. 4 illustrates an example configuration of the example edge computing infrastructure 300 in which the example interface circuitry 310, 320 is combined into an AI-NF infrastructure circuitry 410. The example edge server circuitry 210, 220, 420 includes AI-NF logic circuitry 430-434 and an AI-NF local inventory circuitry 440-444 for the respective edge server circuitry or platform 210, 220, 420. The example edge server circuitry 210, 220, 420 leverages its AI-NF logic circuitry 430-434 to provide access to the AI-NF infrastructure circuitry 410 and expose AI model instances stored in the AI-NF local inventory circuitry 440-444 as discoverable by the AI-NF infrastructure circuitry 410, for example.

As shown in the example of FIG. 4, an edge service 405 can request that the AI-NF logic circuitry 430 execute a given AI model according to a set of parameters or requirements. The request for the AI model from the example service 405 can include information such as an AI-NF inference with a named model, accuracy threshold/requirement, recall, latency/time, conference vector, local resource availability, previously requested model identifier, etc. Results of the AI-NF inference can be used to examine or search the AI-NF local inventory circuitry 440 of the example edge server circuitry 210. The AI-NF inference can also be used to query AI-NF model discovery and offering circuitry 450 of the AI-NF infrastructure circuitry 410. The AI-NF local inventory circuitry 440 can also provide an AI-NF registry entry to the AI-NF model discovery and offering circuitry 450 of the example AI-NF infrastructure circuitry 410. Results from the AI-NF model discovery and offering circuitry 450 and/or from the AI-NF local inventory circuitry 440-444 can be stored in the AI-NF model cache 460, for example.

As such, a query or instruction call for execution from the service 405 can result in a new AI-NF multicast message from the AI-NF infrastructure circuitry 410 to the AI-NF local inventory circuitry 440 with a named model, associated accuracy, other parameter, etc. An AI-NF annotated data set including data named type, inferenced annotation, conference vector, etc., can also be provided by the AI-NF infrastructure circuitry 410 to the AI-NF local inventory circuitry 444, for example. One or more of the AI-NF local inventory circuitry 440-444 can produce set(s) of one or more models 470-475 including associated parameters/characteristics such as accuracy, latency, recall, etc. As models are added, modified, removed, etc., their location and status can be updated with the AI-NF infrastructure circuitry 410.

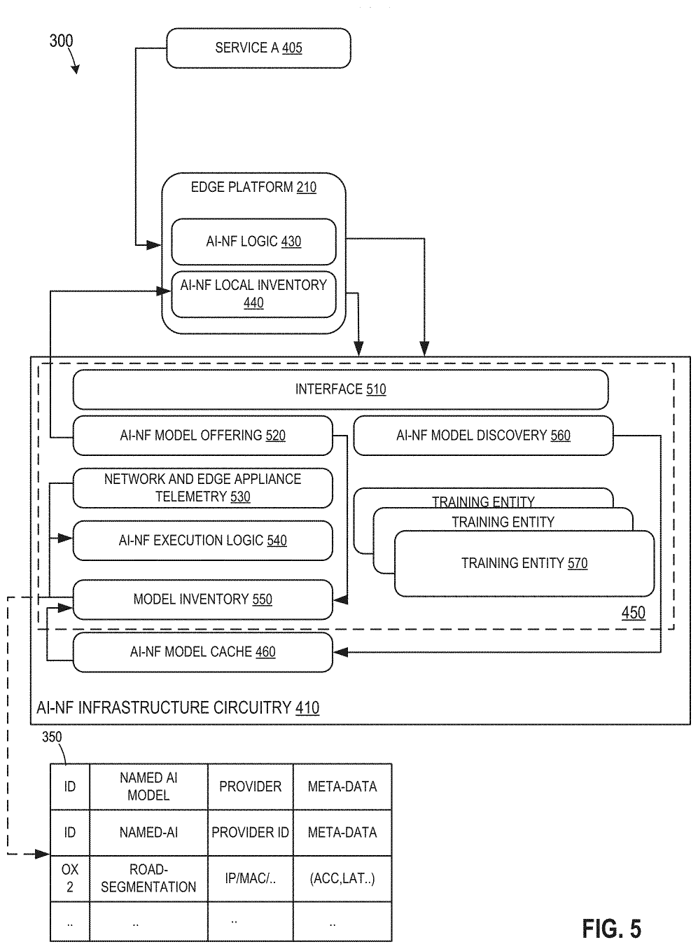

FIG. 5 illustrates an example implementation of the edge computing infrastructure 300 of FIG. 4. As shown in the example of FIG. 5, the example service 405 queries the AI-NF logic circuitry 430 of the edge server circuitry 210 for a particular AI model. For example, the service 405 can pass an AI-NF inference for a named model with a desired accuracy, recall, end-to-end (E2E) latency, local resource availability, prior usage by the service 405, conference vector, etc., to the AI-NF logic circuitry 430 of the edge server circuitry 210. The AI-NF logic circuitry 430 manages E2E execution of AI-NF models. The example AI-NF logic circuitry 430 can query the AI-NF local inventory circuitry 440 for the named model requested by the service 405 and/or can query the AI-NF model offering and discovery circuitry 450 of the example AI-NF infrastructure circuitry 410 to locate the model.

For example, the AI-NF logic circuitry 430 tracks AI-NF model instances that are available in the AI-NF local inventory circuitry 440 and registers the models to keep information consistent between the AI-NF local inventory circuitry 440 and the AI-NF infrastructure circuitry 410. Each instance of an AI-NF model can be associated with metadata such as accuracy, recall, latency, tenant provider, and/or other data that can be mapped into an AI-NF model.

In certain examples, the AI-NF logic circuitry 430 determines a load on the edge server circuitry 210 and a capacity to accommodate execution of one or more AI model instances by the edge server circuitry 210. The example AI-NF logic circuitry 430 serves as a platform interface that one or more applications can use to request the AI-NF infrastructure 410 to execute a particular AI-NF Model (e.g., person detection, etc.).

The example AI-NF logic circuitry 430 manages requests to execute an AI-NF model. As such, the AI-NF logic circuitry 430 processes a request to execute an AI-NF model according to one or more specified parameters. For example, the AI-NF logic circuitry 430 allows the service 405 and/or other application to form a query including information such as AI-Named Function (AI-NF), payload (or a pointer to the payload), restriction, etc. The AI-NF is a global unique identifier (GUID) that identifies the Named Function (e.g., person detection, etc.). The GUID is managed consistently by the AI-NF infrastructure 410 and is discoverable. The payload or pointer to the payload (e.g., global memory address, etc.) specifies content of the function and/or associated query beyond the name, for example. The one or more restrictions indicate one or more constraints, parameters, settings, etc., associated with execution of the AI-NF model (e.g., end-to-end latency, recall, required accuracy for the selected model etc.). The AI-NF logic circuitry 430 can provide available compute capabilities including a list of accelerators and/or other computing circuitry to execute the designed model, for example.

As illustrated in FIG. 5, the example AI-NF model offering and discovery circuitry 450 includes an interface circuitry 510. The example interface circuitry 510 accepts a query (e.g., a query for an AI model from the AI-NF logic circuitry 430, etc.) and/or a response (e.g., providing an AI model from the AI-NF local inventory 440, etc.) from the example edge server circuitry 210 and can route a response (e.g., providing an AI model instance, etc.) to the edge server circuitry 210. For example, the AI-NF logic circuitry 430 can query for an AI model via the interface circuitry 510, and, in response to the query, the AI-NF local inventory 440 can receive an AI-NF annotated data set including data named type, inferenced annotation, conference vector, etc.

The example AI-NF infrastructure circuitry 410 processes the query from the AI-NF logic circuitry 430 to identify and facilitate execution of an AI model (e.g., an AI-NF model, etc.) to return an outcome/result to the service 405. The AI-NF infrastructure circuitry 410 can identify a local edge server circuitry 210, 220, 420, a cloud circuitry 230-240, a portion of the infrastructure circuitry 410, etc., for execution of an instance of an AI-NF model, for example.

In certain examples, the AI-NF logic circuitry 430 from the example edge server circuitry 210 periodically sends results of AI/AI-NF model instances executing on the edge server circuitry 210 to the AI-NF infrastructure circuitry 410. Results can be used for model training, naming of AI-NF models, and/or association of data type(s) with AI model inferences, for example. Results sent to the AI-NF infrastructure circuitry 410 may be selected by the AI-NF logic circuitry 430 based on one or more criterion including a level of confidence associated with the generated prediction, sensitivity (or lack of sensitivity) of the data, data generation condition, etc. In certain examples, the AI-NF logic circuitry 430 instead creates a new model on the edge server circuitry 210.

As shown in the example of FIG. 5, the AI-NF infrastructure circuitry 410 includes an example interface 510, which facilitates interaction between the infrastructure circuitry 410 and one or more circuits such as the edge server circuitry 210, 220, 420, etc. The example AI-NF infrastructure circuitry 410 includes AI-NF model offering circuitry 520, network and edge appliance telemetry circuitry 530, AI-NF execution logic circuitry 540, model inventory circuitry 550, AI-NF model discovery circuitry 560, and one more training entities 570, in addition to the AI-NF model cache 460, for example. The example AI-NF model offering circuitry 520 provides one or more AI models (e.g., to the example AI-NF local inventory 440, etc.) in response to a query. The example AI-NF model discovery circuitry 560 processes a query to identify such model(s).

The example AI-NF model inventory circuitry 550 manages an inventor of AI instances for AI named models that are hosted in the various appliances 210-240, 420, etc., that belong to the example edge infrastructure 300. Each named model instance (e.g., speech to text NN,) has a set of meta-data fields that defines characteristics of the respective model instance (e.g., accuracy, recall, latency, etc.). Each named model instance can be tagged with other data that can be used for data privacy, management, etc., such as general data protection regulation (GDPR, data sovereignty, etc., that can be used by the AI-NF infrastructure circuitry 410 to determine which instance(s) can be used and where such instance(s) can be used. Contextual information can be used to apply one or more policies to AI model instances, for example.

The example AI-NF infrastructure circuitry 410 includes a cache 460 of AI models as well named instances that may not be available in any edge appliance 210-220, 420 but that have been generated over the lifetime of the edge infrastructure 300. Contextual data can be stored with the models in the cache 460 for rapid filtering, for example.

The example AI-NF execution logic circuitry 540 provides infrastructure support to execute and/or route an AI-NF model instance. Similar to the AI-NF logic circuitry 430, the AI-NF execution logic circuitry 540 provides an interface that can be called in order to manage an AI-NF model execution, for example. Parameters associated with the example AI-NF execution logic circuitry 540 can include: AI-Named Function, payload/point, restriction, etc. As described in connection with the example AI-NF logic circuitry 430, the AI-NF is a GUID that identifies an associated named function (e.g., person detection, etc.). The payload or pointer to the payload (e.g., a global memory address, etc.) provides a location of a model/model data in memory. Restriction(s) can be associated with AI-NF execution (e.g., E2E latency, model accuracy, recall, etc.).

The AI-NF execution logic circuitry 540 can include circuitry programmed with logic (e.g., instructions, gates, other circuitry, etc.) to implement an interface that can filter to determine which edge appliances (e.g., the example edge server circuitry 210, 220, 420, etc.) satisfy provided requirements, for example. For example, the AI-NF execution logic circuitry 540 can drive (or help drive) the example interface 510. The interface 510 can filter edge appliances for AI model instances that satisfy meta-data requirements that are not latency- or compute-related (e.g., accuracy, recall, privacy, ownership, proprietary access, etc.), a prescribed E2E latency limit, network latency, compute capacity, etc. For example, network latency can be estimated using telemetry data captured by the network and edge appliance telemetry circuitry 530 (e.g., network telemetry information, edge appliance telemetry information, etc.), historical data on jitter, etc. Compute capacity can be determined for a selected AI model instance and can be based on a current processing load and estimated latency.

For example, telemetry data (e.g., real-time or substantially real-time telemetry data, etc.) from one or more computing elements (e.g., processors, accelerators, etc.) capable of executing a particular model or function (e.g., obstacle detection, person detection, road segmentation, etc.) can be gathered with associated hardware properties to identify and prioritize AI model instances based on one or more criterion such as latency, accuracy, recall, throughput, power, cost, ownership, prior usage, etc. For example, a plurality of NN models for video analytics may be available but behave differently with different resources and different loads. Different NN models to implement the same function in different ways may provide a trade-off between accuracy and latency, for example. Different hardware available to execute different models may also provide trade-off(s) between latency, power, throughput, etc. For example, different types of hardware have different latency behavior depending on the associated load. An FPGA provides a constant latency to perform a model inference while the latency for an accelerator depends on its associated load (e.g., latency increases exponentially with load, etc.). As such, telemetry information (e.g., related to the network, one or more edge servers/appliances, other infrastructure telemetry information, etc.) can be used as part of a model query to identify an available model instance to select. Telemetry information can be used to organize models in the example table 350 according to use case, type of function, accuracy, recall, latency, etc. Such information can also be stored as meta-data associated with the respective model, for example. In certain examples, proprietary or limited access can also be identified with respect to certain models to limit and/or encourage their usage depending the requestor, circumstances, etc.

The AI-NF execution logic circuitry 540 can leverage the telemetry circuitry 530 to determine whether one or more models available in the table 350 satisfy requirements and/or other parameters provided in a query for a model/model type. If no AI model instance satisfies the requirements, the AI-NF execution logic circuitry 540 may perform a lookup internally in the AI-NF model cache 460. A selected model instance can be returned to the example edge server circuitry 210 via the interface 510, the AI-NF model offering circuitry 520, etc., for execution according to one or more provided functional requirements, etc.

In certain examples, the AI-NF model discovery circuitry 560 processes annotated inferences and associated confidence level/score from the edge nodes 210-240, 420, etc. The AI-NF model discovery circuitry 560 uses named annotated data sets (e.g., per domain, per type of model, etc.) to evaluate model variants (e.g., variants of NN topologies, etc.) with different characteristics (e.g., changing size of layers, introducing more CONV layers, etc.) to discover new models with new properties. Once new models are discovered, the models may be announced to the edge appliances and/or stored locally.

In certain examples, the AI-NF infrastructure circuitry 410 includes a list or other set of training entities 570 that can be used to explore mutation of AI models. For example, one or more of the training entities 570 can include models executable to search model inventories, caches, other storage, etc., to inference and identify one or more models and associated properties, characteristics, configuration, etc. Such model(s) can be referred to as query models or search models, for example. Once new models are identified with new properties (e.g., better accuracy, better performance/watt, etc.), the AI-NF infrastructure circuitry 410 may advertise the model to edge nodes 210-240, 420 in the architecture 300. Identified model(s) can be stored in the model cache 460 and indexed in the associated model inventory circuitry 550.

As shown in the example of FIG. 5, the model inventory circuitry 550 can storage identified model information in the example data structure or table 350. The example table 350, stored by the model inventory circuitry 550, in the model cache 460, and/or in another memory, for example, can organize a plurality of AI models by identifier (ID) (e.g., numeric identifier, alphanumeric identifier, code, etc.), name, provider/source (e.g., name, address, etc.), meta-data (e.g., accuracy, recall, latency, etc.), etc. As shown in the example of FIG. 5, the table 350 can store an identifier OX2 for a road-segmentation AI model at an Internet Protocol (IP) and/or media access control (MAC) address. The example model has certain accuracy, latency, recall, etc., indicated in meta-data stored in the table 350 and associated with the model.

In certain examples, hierarchical caching can be used to populate the table 350 and/or store associated model(s) in the model cache 460. Meta-data and/or a profile definition associated with an AI model (e.g., an AI-NF model, etc.) can be used to identify, classify, and store the AI model in the table 350, the cache 460, etc. For example, hierarchical caching and/or other caching mechanism can be used to organize and store models and associated meta-data in the model cache 460. Meta-data stored in the hierarchical cache can be used to determine whether or not a model is a match or fit for a request/query, for example. Information such as a key performance indicator (KPI), service level agreement (SLA), etc., can be used to help ensure that a selected model not only satisfies the request from the requestor (e.g., the service 405, etc.) but satisfies the request within parameters provided such as speed, latency, accuracy, recall, precision, allowed error, quality, etc. Meta-data, parameters, etc., can be used to define layers or levels in a hierarchy of the example cache 460, which, in some examples, can be scalable (e.g., based on available size, number of queries, variety of models, variety of edge devices, setting, etc.).

In certain examples, an evolution of a given AI model can be tracked across one or more edge nodes and stored in the table 350 and/or the associated model cache 460. The meta-data allows the model to be tracked as it evolves and stored based on name. The history and evolution of the model can be logged and made searchable according to model name (e.g., an AI-NF model).

In certain examples, before a model is used, added to the table 350, etc., the model can be validated. An attestation can be associated with the model to enable that model to be stored, tracked, shared, etc. For example, a test inference of the model can be evaluated against a threshold or score to attest to the validity of the model.

In certain examples, a distributed ledger, such as a blockchain, can be used to track evolution of an attested model over time. Such a distributed ledger can be used in conjunction with a vehicle network, for example, to make a model accessible/executable to one or more edge vehicle systems 260 in communication with the example infrastructure 300 (e.g., as part of a vehicle-to-everything (V2X) network, etc.). For example, one or more edge devices (e.g., connected vehicle systems, etc.) 260 may attest a model and coordinate via the distributed ledger to sign or validate a block or entry in the ledger to enable access to execute an instance of the model. In some examples, a model may be customized, proprietary, or otherwise tailored to a vehicle (e.g., a BMW® model, an Audi® model, etc.). In some examples, vehicle-specific models can be organized in the ledger according to type. In some examples, a hybrid model can be organized with a general portion and a vehicle-specific portion, etc.

In certain examples, the table 350, alone or in combination with the model inventory circuitry 550 and the AI-NF model cache 460, can serve as a new model registry. Logic circuitry 430 of the edge server circuitry 210, 220, 420 can interact with the AI-NF model discovery circuitry 560 to register models with the infrastructure circuitry 410. Using the example model inventory circuitry 550 and the model table 350, the infrastructure 410 can be made aware of a model, its function, and meta-data such as accuracy (e.g., percentage, etc.), latency (e.g., milliseconds, etc.), recall (e.g., a number of relevant elements detected (e.g., true positives divided by a number of relevant elements), etc.), etc. The infrastructure 410 can then support and provide the model, which can be organized individually, grouped with others of the same type, linked to prior/other instances of the same model, based on access/authorization, etc. If the edge server circuitry 210, 220, 420 removes a model, the logical circuitry 430 also interacts with the model inventory circuitry 550 to delete an entry for the removed model from the table 350, etc. By providing tags, meta-data, etc., the table 350 enables the AI-NF infrastructure circuitry 410 to automatically apply one or more policies to identify, manage, and deploy models for execution. The table 350 and associated meta-data allows the example AI-NF logic circuitry 430 to estimate wait times, monitor/manage deployed model(s), etc. Such functionality is important when a large number of users are connected to the edge infrastructure 300 with a large number of models deployed for use.

As such, the example AI-NF infrastructure circuitry 410 acts as a switch to connect the requesting service 405 and/or one or more external devices 260 to a model for execution/inference with respect to a particular instance of the model stored on the infrastructure circuitry 410 or on a connected edge server circuitry 210, 220, 420, cloud circuitry 230, 240, etc. In certain examples, rather than employing services to execute AI model inferencing in a particular way, the example AI-NF infrastructure circuitry 410 and its interface 510 provide a switch to dynamically identify and execute a particular model. When the service 405 requests to perform a particular inference on a particular model with a particular payload, the infrastructure circuitry 410 translates and connects the service 405 (e.g., via the edge server circuitry 210, etc.) to the platform or accelerator hosting the model to perform the inferencing.

For example, the service 405 sends a request to the edge server circuitry 210. The request includes a model or model type as well as certain requirements or parameters (e.g., requesting a pedestrian detection model with an accuracy of at least 80% and a response time of no longer than 10 milliseconds, etc.). In certain examples, the request can include information regarding prior usage (e.g., name, location, etc.). In other examples, the request does not include prior usage information. The AI-NF logic circuitry 430 of the edge server circuitry 210 can search locally in its AI-NF local inventory 440 to determine whether the local inventor 440 holds a model that satisfies the specified constraints. The AI-NF logic circuitry 430 can also communicate with the AI-NF infrastructure 410 to provide the model and associated requirement(s) via the interface circuitry 510. The AI-NF model offering circuitry 520 and/or the AI-NF model discovery circuitry 560 identifies a model instance (e.g., using the AI-NF model inventory circuitry 550 and/or the model table 350, etc.) that satisfies the requirements or constraints specified by the service 405 and where that model is located (e.g., hosted by the AI-NF infrastructure circuitry 410, located at one of the edge server circuitry 210, 220, 420, hosted in the cloud circuitry 230, 240, etc.). The query can be based on name, a description of the model function, another identifier, etc. The AI-NF infrastructure circuitry 410 connects the requesting service 405 to the circuitry hosting the selected model for inferencing/execution. The model can be uni-cast to a single requesting service 405, multi-cast to multiple requesting/related service 405, device(s) 260, etc., for example.

While pedestrian detection was used as an example above, the example system 300 can be applied to a variety of AI models (named or otherwise identified), associated functions, etc. For example, other video analytics models can be organized, identified, and deployed using the example infrastructure 300. The example infrastructure 300 can organize and deploy models related to defect detection (e.g., sensor data to be analyzed to detect an anomaly, etc.), factory floor analysis, robot control (e.g., to identify an object and that object's role or function, etc.), smart transportation, retail, other edge-based learning, etc.

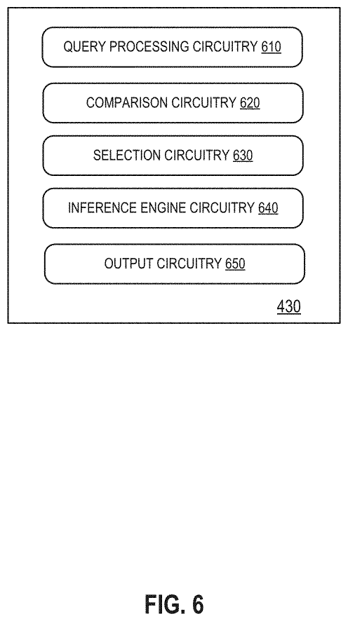

FIG. 6 illustrates an example implementation of the AI-NF logic circuitry 430. A similar configuration can be used to implement the example AI-NF logic circuitry 432, 434, and/or the example AI-NF execution logic 540, for example. The implementation of the AI-NF logic circuitry 430 is provided in connection with FIG. 6 for purposes of illustration only. As shown in the example of FIG. 6, the AI-NF logic circuitry 430 includes query processing circuitry 610, comparison circuitry 620, selection circuitry 630, inference engine circuitry 640, and output circuitry 650.

The example query processing circuitry 610 processes an incoming query or request to locate an AI model corresponding to an identifier, a name, a specified function, etc. The query processing circuitry 610 leverages information provided in the request including one or more requirements, constraints, and/or parameters provided in association with the model/function request. For example, the request may include a required minimum accuracy, recall, latency/responsiveness, etc., that factors into which model instance, among a plurality of the same or similar AI models, can perform the function and satisfy the constraints specified in the request.

The example comparison circuitry 620 compares and/or otherwise evaluates available AI models (e.g., that appear to satisfy the one or more requirements, constraints, parameters, etc., specified in the model request. The comparison circuitry 620 generates a comparison or comparative output from an evaluation of two or more models from the example AI-NF local inventory circuitry 440, the model inventory circuitry 550, the AI-NF model cache 460, and/or the model table 350, etc. The comparison circuitry 620 can compare meta-data associated with models, leverage the inference engine circuitry 640 to evaluate model output, and/or otherwise evaluate two or more models to provide a quantitative comparison output (e.g., a score or other number, etc.), a qualitative comparison output (e.g., which model satisfies more requirements and/or better satisfies requirements, etc.), etc., for the selector circuitry 630 to select one of the AI models evaluated by the comparison circuitry 620.

The example selector circuitry 630 can trigger the output circuitry to provide a selected AI model instance (e.g., an AI-NF model instance, etc.) to a requestor (e.g., the service 405, an edge device 260, the edge server circuitry 210, 220, 420, etc.). Alternatively or additionally, the selector circuitry 630 can trigger the inference engine circuitry 640 to execute or inference the selected model and provide an output to the output circuitry 650 for output to the requestor. The output circuitry 650 can output an identification of the selected AI model, deploy a selected AI model instance, providing a result of model inference/execution, etc.

Thus, the example AI-NF logic circuitry 430 can facilitate name-based and/or other identifier-based model searching and sharing across the edge computing infrastructure 300. The example AI-NF infrastructure circuitry 410 facilitates model searching and sharing among multiple edge server circuitry 210, 220, 420, cloud circuitry 230, 240, connected devices 260, etc. The example model table 350 is populated by the AI-NF infrastructure circuitry 410 in communication with the edge server circuitry 210, 220, 420, etc., and organizes available AI models for query by the AI-NF logic circuitry 430-434 on the edge server circuitry 210, 220, 420 via the AI-NF infrastructure circuitry 410, for example.

The example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 in the illustrated examples of FIGS. 1-6 is/are implemented by a logic circuit such as a hardware processor. However, any other type of circuitry can additionally or alternatively be used such as one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), Coarse Grained Reduced precision architecture (CGRA(s)), image signal processor(s) (ISP(s)), etc. In some examples, the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 in the illustrated examples of FIGS. 1-6 is/are implemented by separate logic circuits.

While example implementations of the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 are illustrated in FIGS. 1-6, one or more of the elements, processes and/or devices illustrated in FIGS. 1-6 can be combined, divided, re-arranged, omitted, eliminated and/or implemented in any other way. Further, the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 can be implemented by hardware, software, firmware and/or any combination of hardware, software and/or firmware. Thus, for example, any of the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 can be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 is/are hereby expressly defined to include a non-transitory computer readable storage device or storage disk such as a memory, a digital versatile disk (DVD), a compact disk (CD), a Blu-ray disk, etc. including the software and/or firmware. Further still, the example computing architectures/apparatus 300 of FIGS. 1-6 can include one or more elements, processes and/or devices in addition to, or instead of, those illustrated in FIGS. 1-6, and/or can include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

In certain examples, a model data structure can be implemented using one or more of the example table 350, a distributed ledger, the example model cache 460, etc.

In certain examples, model inventory circuitry can be implemented using one or more of example inventory circuitry 440-444, 550, etc. In certain examples, model discovery circuitry can be implemented using one or more of the example model offering and discovery circuitry 450, the example model offering circuitry 520, the example model discovery circuitry 560, etc.

In certain examples, execution logic circuitry can be implemented using one or more of the example AI-NF logic circuitry 430-434, the example AI-NF execution logic circuitry 550, etc.

In certain examples, other elements of the example infrastructure circuitry 410 help to implement one or more of these circuitry.

In certain examples, means for managing a model data structure can be implemented using one or more of the example inventory circuitry 440-444, 550, etc.

In certain examples, means for processing a query can be implemented using one or more of the example AI-NF logic circuitry 430-434, the example AI-NF execution logic circuitry 550, the example model offering and discovery circuitry 450, the example model offering circuitry 520, the example model discovery circuitry 560, etc.

In certain examples, means for outputting can be implemented using one or more of the example AI-NF logic circuitry 430-434, the example AI-NF execution logic circuitry 550, etc.

In certain examples, means for identifying can be implemented using one or more of the example inventory circuitry 440-444, 550, the example model offering and discovery circuitry 450, the example model offering circuitry 520, the example model discovery circuitry 560, etc.

In certain examples, means for processing can be implemented using one or more of the example AI-NF logic circuitry 430-434, the example AI-NF execution logic circuitry 550, the example model offering and discovery circuitry 450, the example model offering circuitry 520, the example model discovery circuitry 560, etc.

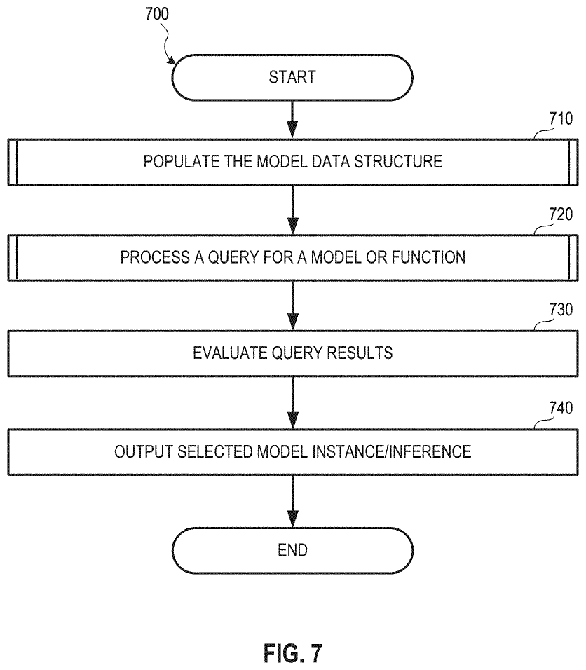

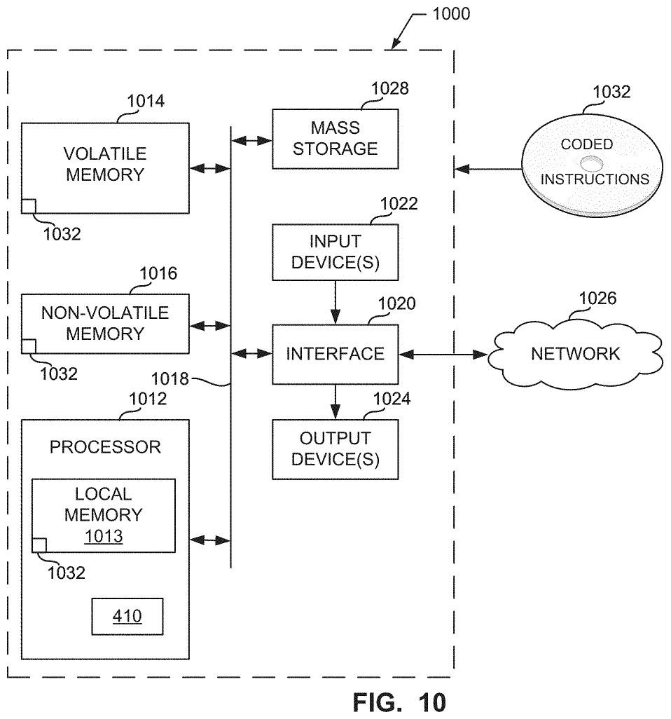

Flowcharts representative of example hardware logic, machine readable instructions, hardware implemented state machines, and/or any combination thereof for implementing the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 is/are shown in FIGS. 7-9. The machine readable instructions can be one or more executable programs or portion(s) of an executable program for execution by a computer processor and/or processor circuitry, such as the processor 1012 shown in the example processor platform 1000 discussed below in connection with FIG. 10. The program may be embodied in software stored on a non-transitory computer readable storage medium such as a CD-ROM, a floppy disk, a hard drive, a DVD, a Blu-ray disk, or a memory/memory circuitry associated with the processor 1012, but the entire program and/or parts thereof could alternatively be executed by a device other than the processor 1012 and/or embodied in firmware or dedicated hardware. The instructions stored on the non-transitory computer readable storage medium can cause at least one processor to perform at least one action or operation, implement at least one function, etc. Further, although the example program is described with reference to the flowcharts illustrated in FIGS. 7-9, many other methods of implementing the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 can alternatively be used. For example, the order of execution of the blocks can be changed, and/or some of the blocks described can be changed, eliminated, or combined. Additionally or alternatively, any or all of the blocks can be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry can be distributed in different network locations and/or local to one or more devices (e.g., a multi-core processor in a single machine, multiple processors distributed across a server rack, etc.).

The machine readable instructions described herein can be stored in one or more of a compressed format, an encrypted format, a fragmented format, a compiled format, an executable format, a packaged format, etc. Machine readable instructions as described herein can be stored as data or a data structure (e.g., portions of instructions, code, representations of code, etc.) that may be utilized to create, manufacture, and/or produce machine executable instructions. For example, the machine readable instructions can be fragmented and stored on one or more storage devices and/or computing devices (e.g., servers) located at the same or different locations of a network or collection of networks (e.g., in the cloud, in edge devices, etc.). The machine readable instructions may involve one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions can be stored in multiple parts, which are individually compressed, encrypted, and stored on separate computing devices, wherein the parts when decrypted, decompressed, and combined form a set of executable instructions that implement one or more functions that can together form a program such as that described herein.

In another example, the machine readable instructions can be stored in a state in which they can be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

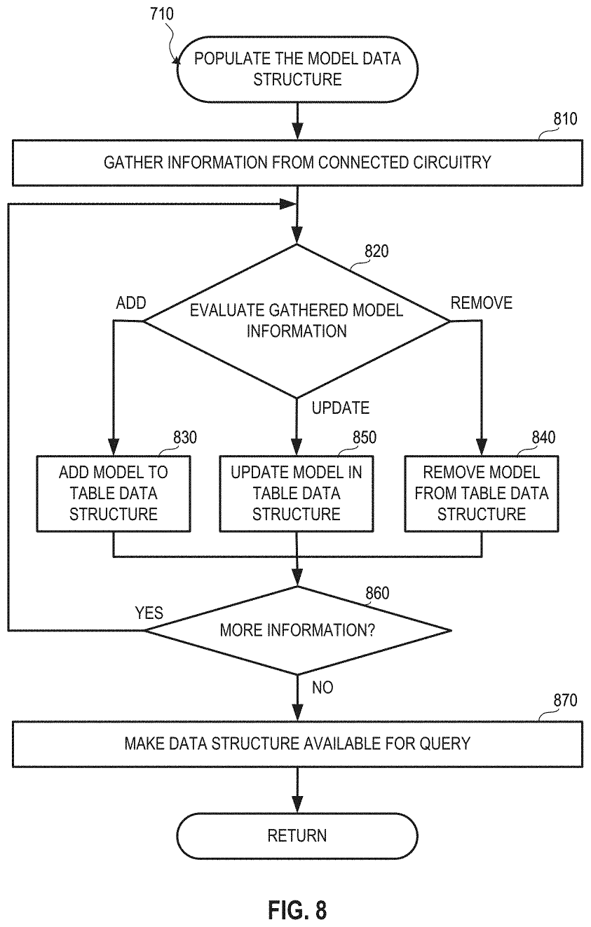

As mentioned above, the example processes of FIGS. 7, 8, and/or 9 can be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 7 is a flowchart representative of example machine-readable instructions that can be executed to implement the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 of FIGS. 1-6. The example process 700 of the illustrated example of FIG. 7 begins with formation and/or update of the model table and/or other data structure 350. (Block 710). The example table 350 can be generated by querying the local inventory circuitry 440-444 of each connected edge server circuitry 210, 220, 420, querying the AI-NF logic circuitry 430-434 of each connected edge server circuitry 210, 220, 420, querying each connected cloud circuitry 230-240, triggering the AI-NF model discovery circuitry 560, etc. The table 350 and the model inventory circuitry 550 can be generated and/or updated based on the query results. The model inventory circuitry 550 can drive the query and maintain the table, for example, which can be initiated by the AI-NF logic circuitry 430-434 (e.g., in response to a query or change at the edge server circuitry 210, 220, 420, etc.), the AI-NF model discovery circuitry 560 (e.g., in response to an initialization, a request from the edge server circuitry 210, 220, 420, etc.), etc.). The table 350 identifies available models by identifier, name, type, source, and associated meta-data, for example. Meta-data can be used to specify characteristics of the model and its source or host such as accuracy, recall, latency, power, etc. The AI-NF local inventory circuitry 440 and/or the model inventory circuitry 550 can also be updated based on the content of the table 350, for example.

In certain examples, AI models can be organized in a blockchain or other distributed ledger instead of or in addition to the example table 350. Using the blockchain/distributed ledger provides a level of attestation to track the status and evolution of models in the blockchain or other ledger.

The table 350 can be queried such as by the AI-NF logic circuitry 430-434, the AI-NF model discovery circuitry 560, the AI-NF model offering circuitry 520, the AI-NF execution logic circuitry 540, etc. (Block 720). For example, in response to a request for a model or associated function from the service 405, the AI-NF logic circuitry 430 of the edge server circuitry 210, 220, 420 initiates a query of the model table 350 via the interface 510 of the AI-NF infrastructure circuitry 410. The AI-NF logic circuitry 430-434 can also query its local AI-NF inventory circuitry 440-444 and/or the model inventory circuitry 550, the model cache 460, etc., in response to a request from the service 405. One or more edge devices 260 can also initiate a query via the AI-NF infrastructure circuitry 410 as well. The query identifies one or more models from the table 350, cache 460, etc., for comparison to one or more requirements/criterion/constraints provided as part of the query. The comparison (e.g., by the AI-NF logic circuitry 430-434, the AI-NF execution logic circuitry 540, the AI-NF model offering circuitry 520, and/or the AI-NF model discovery circuitry 560 generates a ranking of models with respect to the one or more requirements/criterion/constraints and/or with respect to each other, a score and/or confidence level associated with each model with respect to the one or more requirements/criterion/constraints and/or with respect to each other, a binary indication of satisfactory or unsatisfactory with respect to the one or more requirements/criterion/constraints, etc. As such, the logic circuitry 430-434, 540, etc., and/or other circuitry of the example infrastructure 410 can evaluate one or more available models with respect to specified requirements/criterion/constraints/etc., and/or with respect to each other based on processing of associated meta-data, inferencing of the model(s), etc. For example, the query processing circuitry 610 of the example AI-NF logic circuitry 430 can break down the query and identify applicable model(s) and associated meta-data, output, etc.

The comparative query results are then evaluated for a best fit based on the one or more requirements, criteria, constraints, etc. (Block 730). For example, the comparison circuitry 620 of the example AI-NF logic circuitry 430 compares output of the identified models, scores and/or confidence level associated with each of the identified models, other indications provided by the query processing circuitry 610. The selection circuitry 630 selects a model that is determined to be a best fit to the query based on results from the comparison circuitry 620, for example.

The selected AI model (or an instance of the selected AI model) is then made available to the requestor. (Block 740). For example, the output circuitry 640 of the example AI-NF logic circuitry 430 deploys an instance of the selected model to the requestor and/or makes the selected model available for execution to provide an output/outcome to the requestor. In certain examples, the selected AI model (e.g., an AI-NF model, etc.) is stored locally at the edge server circuitry 210, 220, 420. In other examples, the AI-NF infrastructure 410 enables a requestor at one edge server circuitry 210 to be connected to a model identified at another edge server circuitry 220 via the table 350 and associated model inventory circuitry 550.

FIG. 8 is a flowchart providing further example detail regarding populating the model data structure, such as described above in connection with Block 710 of the example of FIG. 7. The example table or data structure 350 can be built and/or otherwise maintained by polling and/or otherwise gathering information from connected servers and/or other devices to populate the table 350. (Block 810). For example, each of the edge server circuitry 210, 220, 420 can be polled and/or otherwise queried to identify model(s) stored in their local inventory circuitry 440-444. Cloud circuitry 230, 240 can also be queried to identify model(s) stored in the cloud. The model inventory circuitry 550 of the AI-NF infrastructure 410 can also be polled and/or indexed to identify model(s) stored in the model cache 460, etc., for example. Polling and/or indexing can also identify models that have been changed, removed, etc. In certain examples, a publish/subscribe model can be established with connected circuitry such that the edge server circuitry 210, 220, 420 messages the model discovery circuitry 560 and/or the model offering circuitry 420 to notify the AI-NF infrastructure 410 of a change such as an added model, a removed model, a changed model, etc.

Gathered model information is then evaluated to determine whether one or more models is to be added to the table 350, removed from the table 350, or modified in the table 350. (Block 820). When a model has been identified to be added to the table 350, an entry associated with the model is added to the table data structure 350. (Block 830). For example, information such as a model name (e.g., AI-NF, etc.), identifier (e.g., a numeric or alphanumeric identifier, etc.), type, source/provider, characteristics or meta-data, etc., can be added as an entry to the table data structure 350. In certain examples, an associated model instance may be copied to the AI-NF model cache 460.

When a model in the table 350 is to be removed (e.g., because that model is no longer stored in the edge server circuitry 210, 220, 420, etc.), then the entry associated with that model in the table 350 is removed. (Block 840). In certain examples, if the model is stored in the AI-NF model cache 460, that model can be purged or otherwise removed from the cache 460.

When a model already identified in the table 350 is to be updated, then the entry associated with that model is updated based on reported change(s). (Block 850). For example, one or more of the model name (e.g., AI-NF, etc.), identifier (e.g., a numeric or alphanumeric identifier, etc.), type, source/provider, characteristics or meta-data, etc., can be updated in the entry associated with the model in the table data structure 350. In certain examples, an associated model instance may be updated in the AI-NF model cache 460.

The gathered model information is evaluated to determine whether further changes to the table 350 (e.g., add, remove, update, etc.) are to be made. (Block 860). If further changes are to be made based on the gathered information (e.g., one or more models to add, remove, and/or update), then control reverts to Block 820 to process the information and trigger a next action with respect to the table 350. If no further changes are to be made, then the data model table 350 is made available for query. (Block 870).

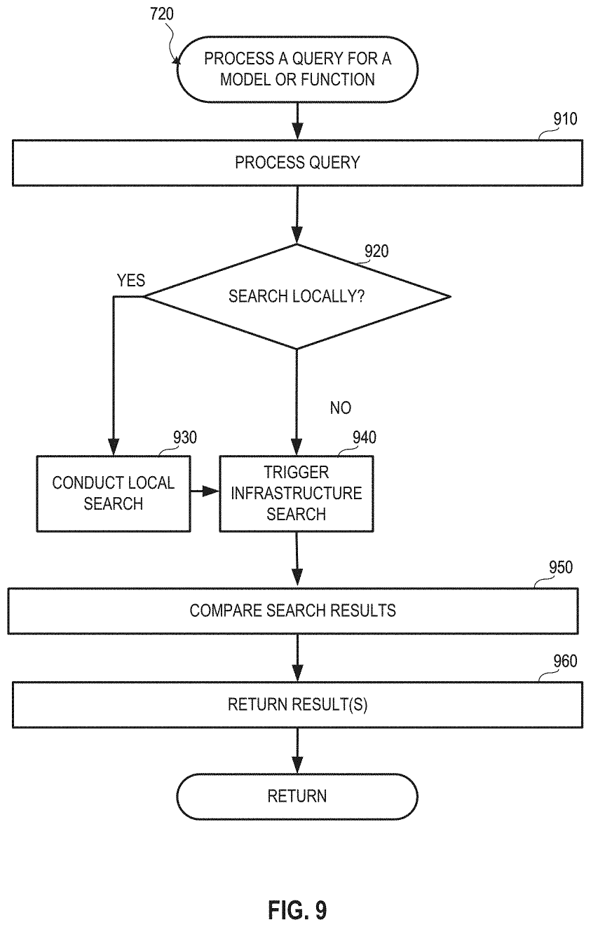

FIG. 9 is a flowchart providing further example detail regarding processing a query for a model or function, such as described above in connection with Block 720 of the example of FIG. 7. For example, a query is received by the edge server circuitry 210 from a service 405 and is evaluated to determine content of the query. (Block 910). For example, the AI-NF logic circuitry 430 processes the request/query to determine whether the request is for a named or otherwise identified model, for a function, etc. The AI-NF logic circuitry 430 transforms the request into a query for the associated model resource. The AI-NF logic circuitry 430 can first search locally (e.g., in the AI-NF local inventory 440, etc.) to determine whether it holds a model that satisfies the request. (Block 920). If a local search is to be performed, for example, the AI-NF logic circuitry 430 determines whether one or more models in the AI-NF local inventory circuitry 440 correspond to the requested model name and/or function and also satisfy (e.g., based on an evaluation of meta-data) one or more requirements, constraints, criterion, other parameters, etc., specified in the request (e.g., accuracy, recall, latency, etc.). (Block 930).

Then, a query to the AI-NF infrastructure circuitry 410 is performed. (Block 940). For example, the table 350 can be queried such as by the AI-NF logic circuitry 430-434, the AI-NF model discovery circuitry 560, the AI-NF model offering circuitry 520, the AI-NF execution logic circuitry 540, etc., to identify one or more models from the table 350, cache 460, etc., for comparison to one or more requirements/criterion/constraints provided as part of the query.

Search results from the local and/or infrastructure searches can be compared with respect to each other and with respect to the one or more requirements, constraints, criterion, other parameters, etc., specified in the request (e.g., accuracy, recall, latency, etc.). (Block 950). The comparison (e.g., by the AI-NF logic circuitry 430-434, the AI-NF execution logic circuitry 540, the AI-NF model offering circuitry 520, and/or the AI-NF model discovery circuitry 560 generates a ranking of models with respect to the one or more requirements/criterion/constraints and/or with respect to each other, a score and/or confidence level associated with each model with respect to the one or more requirements/criterion/constraints and/or with respect to each other, a binary indication of satisfactory or unsatisfactory with respect to the one or more requirements/criterion/constraints, etc. As such, the logic circuitry 430-434, 540, etc., and/or other circuitry of the example infrastructure 410 can evaluate one or more available models with respect to specified requirements/criterion/constraints/etc., and/or with respect to each other based on processing of associated meta-data, inferencing of the model(s), etc. For example, the query processing circuitry 610 of the example AI-NF logic circuitry 430 can break down the query and identify applicable model(s) and associated meta-data, output, etc. Result(s) of the comparison can be returned to enable selection of a best fit model, etc. (Block 960).

Thus, certain examples facilitate name-based model and/or function searching across multiple circuits in an edge infrastructure. The example infrastructure enables coordination, consistency, and access across multiple edge servers, cloud servers, and connected edge devices, for example. Certain examples generate a table data structure that is populated by the infrastructure in communication with the edge servers, etc., and organizes available AI models for query by logic on the edge server, etc., via the infrastructure.

FIG. 10 is a block diagram of an example processor platform 1100 structured to execute the instructions of FIGS. 7-9 to implement the example cloud infrastructure 110, the example edge computing infrastructure 120, the example edge devices 160-164, 260, the example edge server circuitry 210, 220, 420, the example cloud circuitry 230-240, the example network 250, the example interfaces 310-340, 360, the example AI-NF infrastructure circuitry 410, and/or, more generally, the example edge computing infrastructure 300 of FIGS. 1-6. The processor platform 1000 can be, for example, a server, a personal computer, a workstation, a self-learning machine (e.g., a neural network), a mobile device (e.g., a cell phone, a smart phone, a tablet such as an iPad™), an Internet appliance, a gaming console, a headset or other wearable device, or other type of computing device.

The processor platform 1000 of the illustrated example includes a processor 1012. The processor 1012 of the illustrated example is hardware. For example, the processor 1012 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 1012 implements the example AI-NF infrastructure circuitry 410. The example processor 1012 can similarly implement the example edge server circuitry 210, 220, 420, the example cloud circuitry 230, 240, the example edge device 260, etc.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 can be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1016 can be implemented by flash memory and/or any other desired type of memory device. Access to the main memory 1014, 1016 is controlled by a memory controller.

The processor platform 1000 of the illustrated example also includes an interface circuit 1020. The interface circuit 1020 can be implemented by any type of interface standard, such as an Ethernet interface, a universal serial bus (USB), a Bluetooth® interface, a near field communication (NFC) interface, and/or a PCI express interface.

In the illustrated example, one or more input devices 1022 are connected to the interface circuit 1020. The input device(s) 1022 permit(s) a user to enter data and/or commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1020 of the illustrated example, thus, typically includes a graphics driver card, a graphics driver chip, and/or a graphics driver processor.

The interface circuit 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1026. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, redundant array of independent disks (RAID) systems, and digital versatile disk (DVD) drives.

The machine executable instructions 1032 of FIGS. 7-9 can be stored in the mass storage device 1028, in the volatile memory 1014, in the non-volatile memory 1016, and/or on a removable non-transitory computer readable storage medium such as a CD or DVD.

In certain examples, the above example computing apparatus 300, etc., of FIGS. 1-6 can be implemented on an edge node of an edge network. The edge node, for example, is a computing endpoint that is deployed by an edge computing environment such as a base station that has a computing rack integrated into the base of a tower or a regional office that may have server racks as well as a mobile edge node such as a cell phone, smart automobile, drone etc. In an IoT network, mobile edge nodes can be considered as part of the IoT network as well as part of an edge network. IoT and industrial internet of things (IIoT) nodes may include stationary IoT nodes including an IoT network in which the main focus of the IoT node is to host a particular type of sensing technology or cyber-physical automation technology such as factory automation, robotics, autonomics, etc.

In certain examples, chiplets can be composed in various combinations in ASICs, FPGA, SoC, etc., on an IoT or other edge node to provide flexible configuration within a chiplet layout geometry. Security attestation and access regulation can then be dynamically determined based on configuration, task, other usage, location, etc.

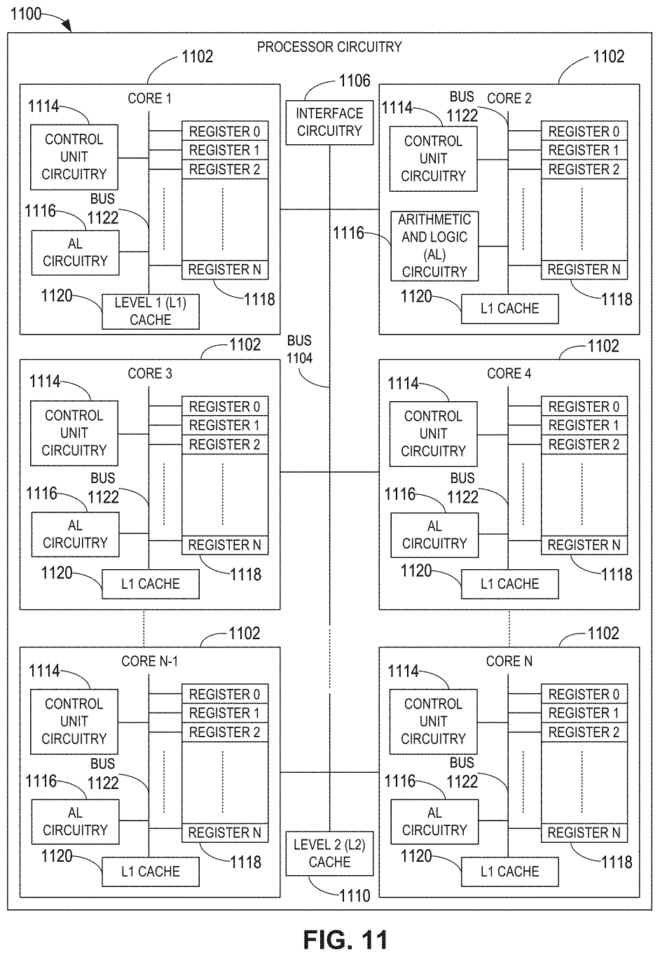

FIG. 11 is a block diagram of an example implementation of the processor circuitry 1000 of FIG. 10. In this example, the processor circuitry 1000 of FIG. 10 is implemented by a microprocessor 1100. For example, the microprocessor 1100 may implement multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by an example bus 1104. In some examples, the bus 1104 may implement a communication bus to effectuate communication associated with one(s) of the cores 1102. For example, the bus 1104 may implement at least one of an Inter-Integrated Circuit (I2C) bus, a Serial Peripheral Interface (SPI) bus, a PCI bus, or a PCIe bus. Additionally or alternatively, the bus 1104 may implement any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the L1 cache 1120, and an example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating point operations. In yet other examples, the AL circuitry 1116 may include first AL circuitry that performs integer based operations and second AL circuitry that performs floating point operations. In some examples, the AL circuitry 1116 may be referred to as an Arithmetic Logic Unit (ALU). The registers 1118 are semiconductor-based structures to store data and/or instructions such as results of one or more of the operations performed by the AL circuitry 1116 of the corresponding core 1102. For example, the registers 1118 may include vector register(s), SIMD register(s), general purpose register(s), flag register(s), segment register(s), machine specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure including distributed throughout the core 1102 to shorten access time. The bus 1122 may implement at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

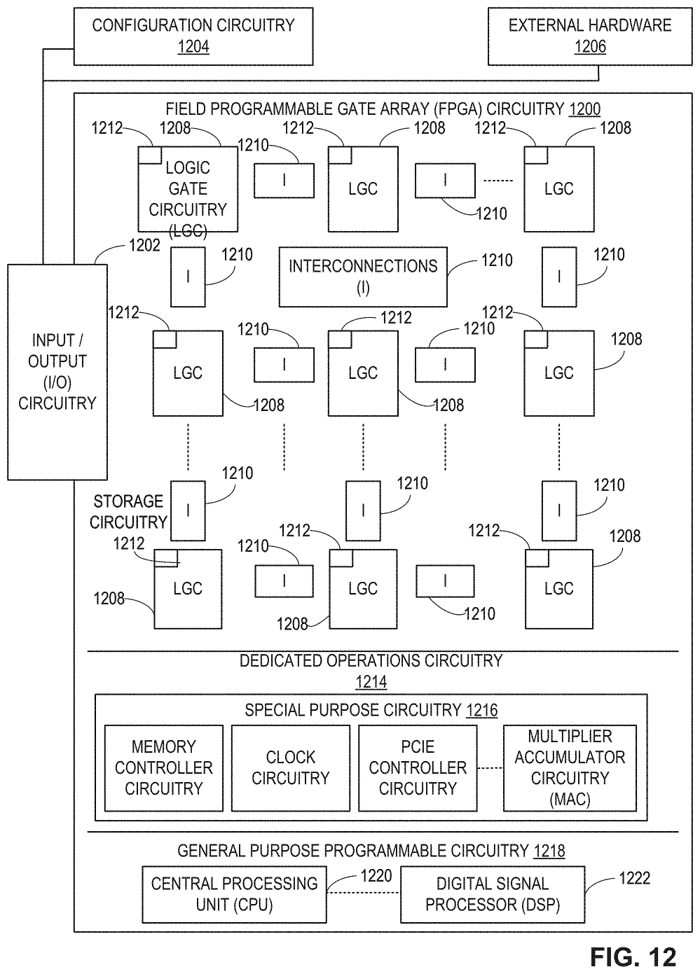

FIG. 12 is a block diagram of another example implementation of the processor circuitry 1000 of FIG. 10. In this example, the processor circuitry 1012 is implemented by FPGA circuitry 1200. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the machine readable instructions in hardware and, thus, can often execute the operations faster than they could be performed by a general purpose microprocessor executing the corresponding software.

More specifically, in contrast to the microprocessor 1100 of FIG. 11 described above (which is a general purpose device that may be programmed to execute some or all of the machine readable instructions represented by the flowcharts of FIGS. 7-9 but whose interconnections and logic circuitry are fixed once fabricated), the FPGA circuitry 1200 of the example of FIG. 12 includes interconnections and logic circuitry that may be configured and/or interconnected in different ways after fabrication to instantiate, for example, some or all of the machine readable instructions represented by the flowcharts of FIGS. 7-9. In particular, the FPGA 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the software represented by the flowcharts of FIGS. 7-9. As such, the FPGA circuitry 1200 may be structured to effectively instantiate some or all of the machine readable instructions of the flowcharts of FIGS. 7-9 as dedicated logic circuits to perform the operations corresponding to those software instructions in a dedicated manner analogous to an ASIC. Therefore, the FPGA circuitry 1200 may perform the operations corresponding to the some or all of the machine readable instructions of FIGS. 7-9 faster than the general purpose microprocessor can execute the same.

In the example of FIG. 12, the FPGA circuitry 1200 is structured to be programmed (and/or reprogrammed one or more times) by an end user by a hardware description language (HDL) such as Verilog. The FPGA circuitry 1200 of FIG. 12, includes example input/output (I/O) circuitry 1202 to obtain and/or output data to/from example configuration circuitry 1204 and/or external hardware (e.g., external hardware circuitry) 1206. For example, the configuration circuitry 1204 may implement interface circuitry that may obtain machine readable instructions to configure the FPGA circuitry 1200, or portion(s) thereof. In some such examples, the configuration circuitry 1204 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1206 may implement the microprocessor 1100 of FIG. 11. The FPGA circuitry 1200 also includes an array of example logic gate circuitry 1208, a plurality of example configurable interconnections 1210, and example storage circuitry 1212. The logic gate circuitry 1208 and interconnections 1210 are configurable to instantiate one or more operations that may correspond to at least some of the machine readable instructions of FIGS. 7-9 and/or other desired operations. The logic gate circuitry 1208 shown in FIG. 12 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations. The logic gate circuitry 1208 may include other electrical structures such as look-up tables (LUTs), registers (e.g., flip-flops or latches), multiplexers, etc.

The interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example Dedicated Operations Circuitry 1214. In this example, the Dedicated Operations Circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the processor circuitry 1012 of FIG. 10, many other approaches are contemplated. For example, as mentioned above, modern FPGA circuitry may include an on-board CPU, such as one or more of the example CPU 1220 of FIG. 12. Therefore, the processor circuitry 1012 of FIG. 10 may additionally be implemented by combining the example microprocessor 1100 of FIG. 11 and the example FPGA circuitry 1200 of FIG. 12. In some such hybrid examples, a first portion of the machine readable instructions represented by the flowcharts of FIGS. 7-9 may be executed by one or more of the cores 1102 of FIG. 11 and a second portion of the machine readable instructions represented by the flowchart of FIGS. 7-9 may be executed by the FPGA circuitry 1200 of FIG. 12.

In some examples, the processor circuitry 1012 of FIG. 10 may be in one or more packages. For example, the processor circuitry 1100 of FIG. 11 and/or the FPGA circuitry 1200 of FIG. 12 may be in one or more packages. In some examples, an XPU may be implemented by the processor circuitry 1012 of FIG. 10, which may be in one or more packages. For example, the XPU may include a CPU in one package, a DSP in another package, a GPU in yet another package, and an FPGA in still yet another package.

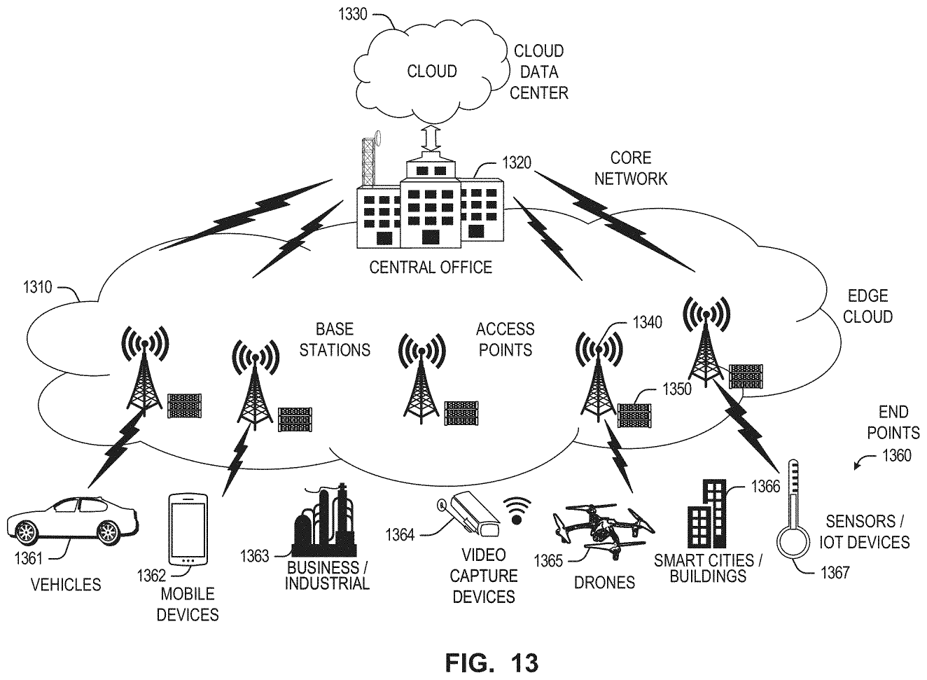

FIG. 13 is a block diagram 1300 showing an overview of a configuration for edge computing, which includes a layer of processing referred to in many of the following examples as an “edge cloud”. As shown, the edge cloud 1310 is co-located at an edge location, such as an access point or base station 1340, a local processing hub 1350, or a central office 1320, and thus may include multiple entities, devices, and equipment instances. The edge cloud 1310 is located much closer to the endpoint (consumer and producer) data sources 1360 (e.g., autonomous vehicles 1361, user equipment 1362, business and industrial equipment 1363, video capture devices 1364, drones 1365, smart cities and building devices 1366, sensors and IoT devices 1367, etc.) than the cloud data center 1330. Compute, memory, and storage resources which are offered at the edges in the edge cloud 1310 are critical to providing ultra-low latency response times for services and functions used by the endpoint data sources 1360 as well as reduce network backhaul traffic from the edge cloud 1310 toward cloud data center 1330 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

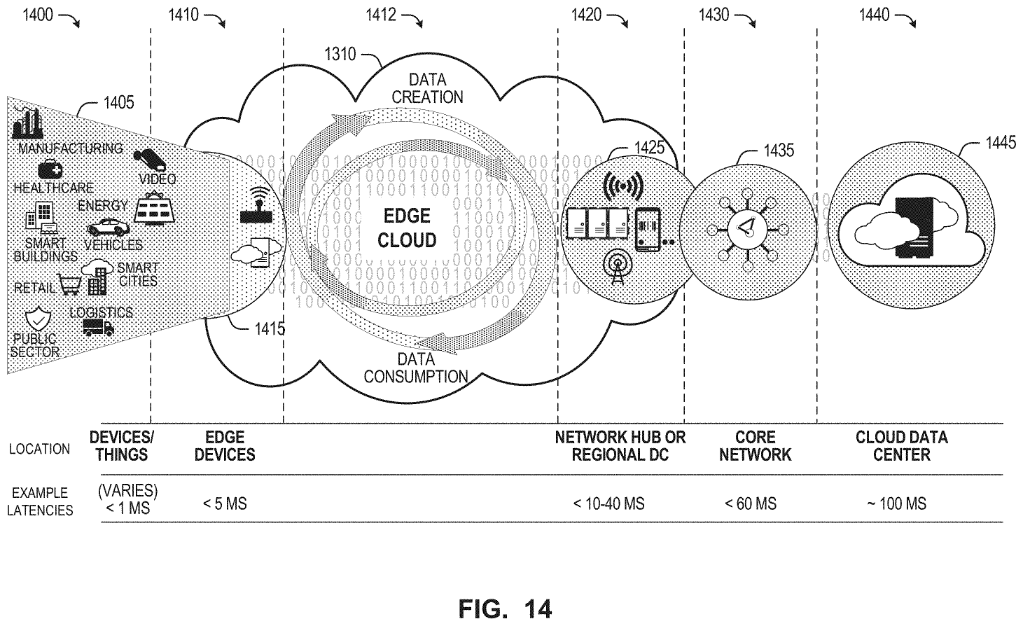

FIG. 14 illustrates operational layers among endpoints, an edge cloud, and cloud computing environments. Specifically, FIG. 14 depicts examples of computational use cases 1405, utilizing the edge cloud 1310 among multiple illustrative layers of network computing. The layers begin at an endpoint (devices and things) layer 1400, which accesses the edge cloud 1310 to conduct data creation, analysis, and data consumption activities. The edge cloud 1310 may span multiple network layers, such as an edge devices layer 1410 having gateways, on-premise servers, or network equipment (nodes 1415) located in physically proximate edge systems; a network access layer 1420, encompassing base stations, radio processing units, network hubs, regional data centers (DC), or local network equipment (equipment 1425); and any equipment, devices, or nodes located therebetween (in layer 1412, not illustrated in detail). The network communications within the edge cloud 1310 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1400, under 5 ms at the edge devices layer 1410, to even between 10 to 40 ms when communicating with nodes at the network access layer 1420. Beyond the edge cloud 1310 are core network 1430 and cloud data center 1440 layers, each with increasing latency (e.g., between 50-60 ms at the core network layer 1430, to 100 or more ms at the cloud data center layer). As a result, operations at a core network data center 1435 or a cloud data center 1445, with latencies of at least 50 to 100 ms or more, will not be able to accomplish many time-critical functions of the use cases 1405. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1435 or a cloud data center 1445, a central office or content data network may be considered as being located within a “near edge” layer (“near” to the cloud, having high latency values when communicating with the devices and endpoints of the use cases 1405), whereas an access point, base station, on-premise server, or network gateway may be considered as located within a “far edge” layer (“far” from the cloud, having low latency values when communicating with the devices and endpoints of the use cases 1405). It will be understood that other categorizations of a particular network layer as constituting a “close”, “local”, “near”, “middle”, or “far” edge may be based on latency, distance, number of network hops, or other measurable characteristics, as measured from a source in any of the network layers 1400-1440.

The various use cases 1405 may access resources under usage pressure from incoming streams, due to multiple services utilizing the edge cloud. To achieve results with low latency, the services executed within the edge cloud 1310 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1310 may provide the ability to serve and respond to multiple applications of the use cases 1405 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 1310 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1310 (network layers 1400-1440), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1310.

As such, the edge cloud 1310 is formed from network components and functional features operated by and within edge gateway nodes, edge aggregation nodes, or other edge compute nodes among network layers 1410-1430. The edge cloud 1310 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1310 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

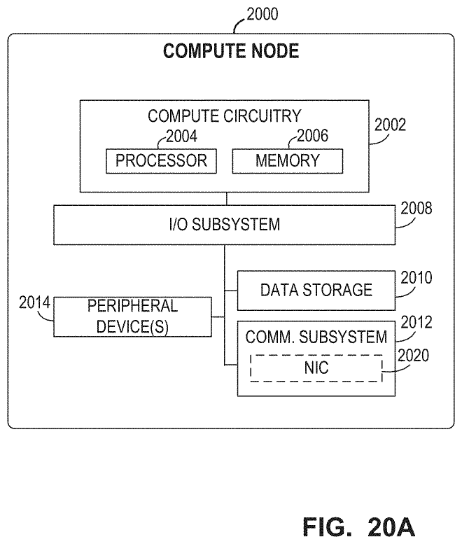

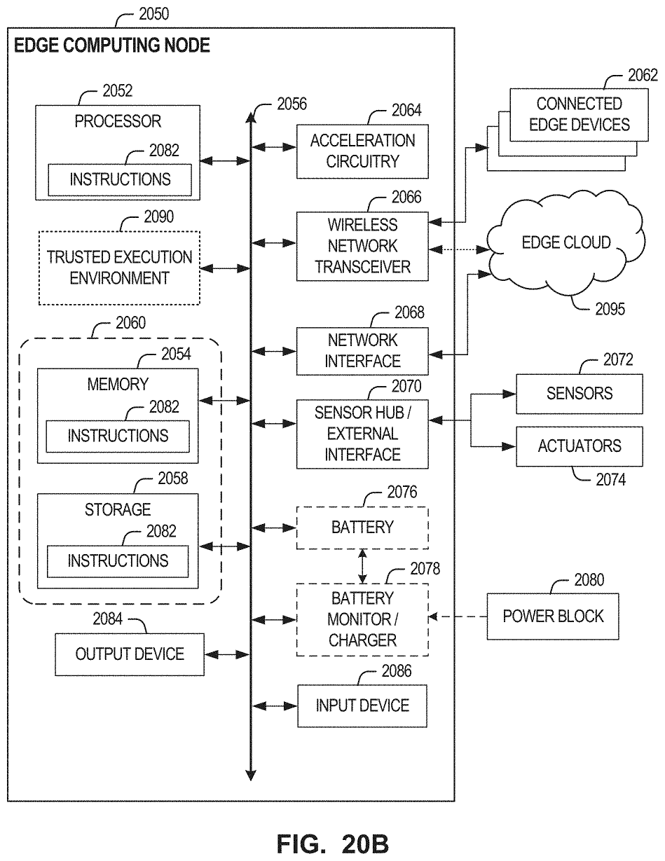

The network components of the edge cloud 1310 may be servers, multi-tenant servers, appliance computing devices, and/or any other type of computing devices. For example, the edge cloud 1310 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 20B. The edge cloud 1310 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code, or scripts.

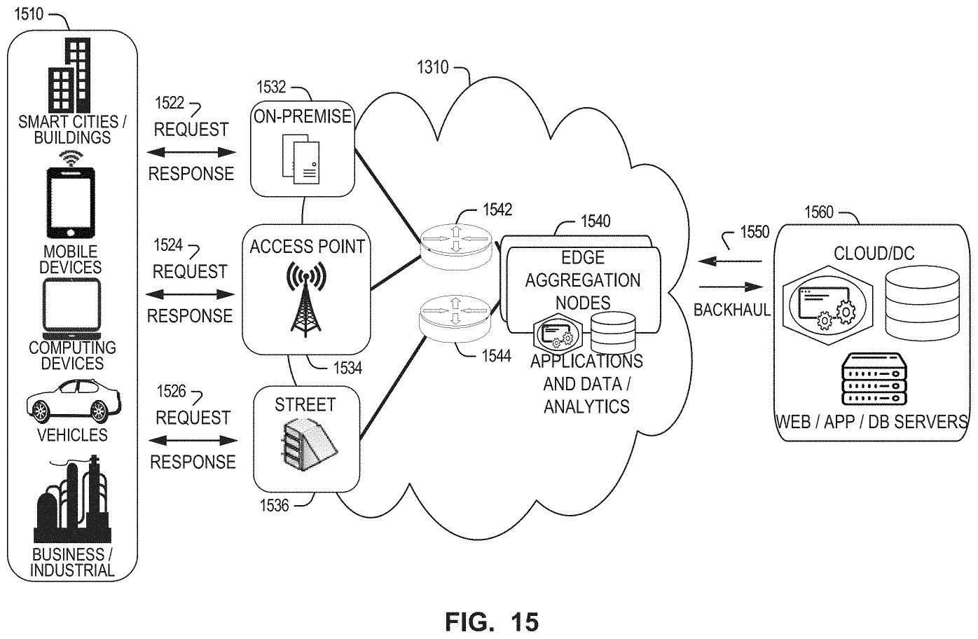

In FIG. 15, various client endpoints 1510 (in the form of mobile devices, computers, autonomous vehicles, business computing equipment, industrial processing equipment) exchange requests and responses that are specific to the type of endpoint network aggregation. For instance, client endpoints 1510 may obtain network access via a wired broadband network, by exchanging requests and responses 1522 through an on-premise network system 1532. Some client endpoints 1510, such as mobile computing devices, may obtain network access via a wireless broadband network, by exchanging requests and responses 1524 through an access point (e.g., cellular network tower) 1534. Some client endpoints 1510, such as autonomous vehicles may obtain network access for requests and responses 1526 via a wireless vehicular network through a street-located network system 1536. However, regardless of the type of network access, the TSP may deploy aggregation points 1542, 1544 within the edge cloud 1310 to aggregate traffic and requests. Thus, within the edge cloud 1310, the TSP may deploy various compute and storage resources, such as at edge aggregation nodes 1540, to provide requested content. The edge aggregation nodes 1540 and other systems of the edge cloud 1610 are connected to a cloud or data center 1560, which uses a backhaul network 1550 to fulfill higher-latency requests from a cloud/data center for websites, applications, database servers, etc. Additional or consolidated instances of the edge aggregation nodes 1540 and the aggregation points 1542, 1544, including those deployed on a single server framework, may also be present within the edge cloud 1610 or other areas of the TSP infrastructure.

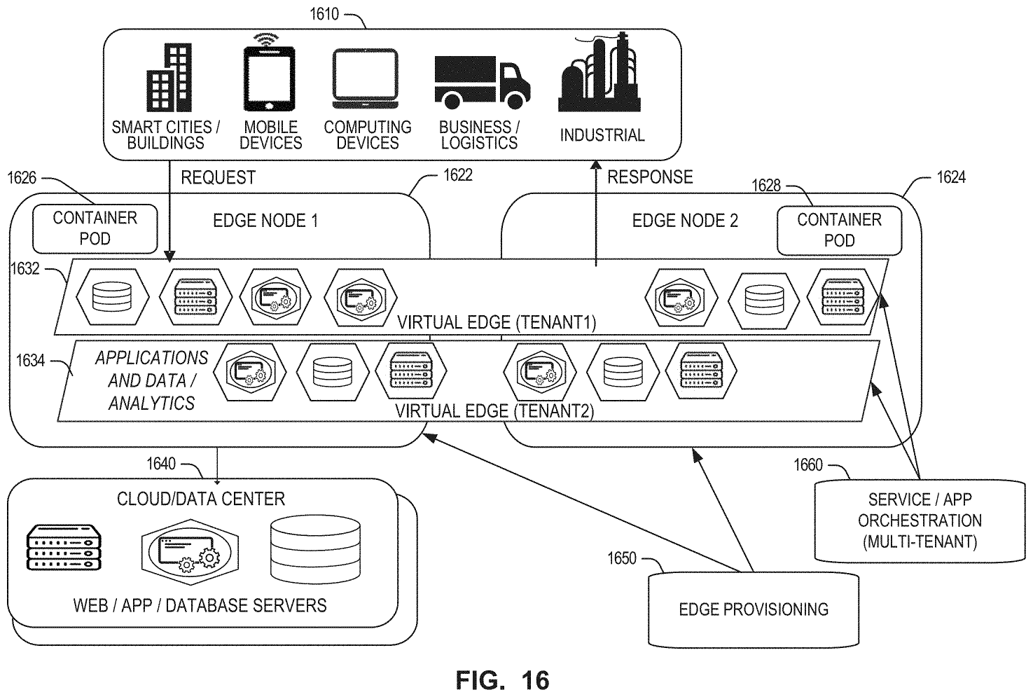

FIG. 16 illustrates deployment and orchestration for virtualized and container-based edge configurations across an edge computing system operated among multiple edge nodes and multiple tenants (e.g., users, providers) which use such edge nodes. Specifically, FIG. 16 depicts coordination of a first edge node 1622 and a second edge node 1624 in an edge computing system 1600, to fulfill requests and responses for various client endpoints 1610 (e.g., smart cities/building systems, mobile devices, computing devices, business/logistics systems, industrial systems, etc.), which access various virtual edge instances. Here, the virtual edge instances 1632, 1634 provide edge compute capabilities and processing in an edge cloud, with access to a cloud/data center 1640 for higher-latency requests for websites, applications, database servers, etc. However, the edge cloud enables coordination of processing among multiple edge nodes for multiple tenants or entities.

In the example of FIG. 16, these virtual edge instances include: a first virtual edge 1632, offered to a first tenant (Tenant 1), which offers a first combination of edge storage, computing, and services; and a second virtual edge 1634, offering a second combination of edge storage, computing, and services. The virtual edge instances 1632, 1634 are distributed among the edge nodes 1622, 1624, and may include scenarios in which a request and response are fulfilled from the same or different edge nodes. The configuration of the edge nodes 1622, 1624 to operate in a distributed yet coordinated fashion occurs based on edge provisioning functions 1650. The functionality of the edge nodes 1622, 1624 to provide coordinated operation for applications and services, among multiple tenants, occurs based on orchestration functions 1660.

It should be understood that some of the devices in 1610 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 1622, 1624 may operate as security feature enforcement points for local resources allocated to multiple tenants per node. Additionally, tenant runtime and application execution (e.g., in instances 1632, 1634) may serve as an enforcement point for a security feature that creates a virtual edge abstraction of resources spanning potentially multiple physical hosting platforms. Finally, the orchestration functions 1660 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes often use containers, FaaS engines, Servlets, servers, or other computation abstraction that may be partitioned according to a DICE layering and fan-out structure to support a RoT context for each. Accordingly, the respective RoT spanning devices 1610, 1622, and 1640 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 16. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

For instance, each edge node 1622, 1624 may implement the use of containers, such as with the use of a container “pod” 1626, 1628 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 1932, 1934 are partitioned according to the needs of each container.

With the use of container pods, a pod controller oversees the partitioning and allocation of containers and resources. The pod controller receives instructions from an orchestrator (e.g., orchestrator 1660) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 1660 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

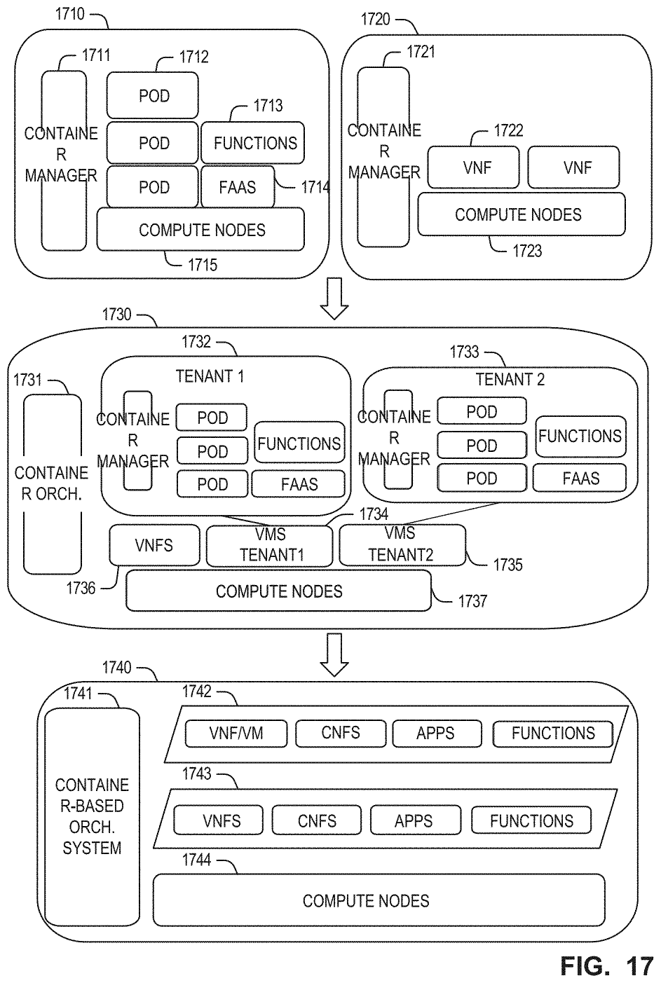

FIG. 17 illustrates additional compute arrangements deploying containers in an edge computing system. As a simplified example, system arrangements 1710, 1720 depict settings in which a pod controller (e.g., container managers 1711, 1721, and container orchestrator 1731) is adapted to launch containerized pods, functions, and functions-as-a-service instances through execution via compute nodes (1715 in arrangement 1710), or to separately execute containerized virtualized network functions through execution via compute nodes (1723 in arrangement 1720). This arrangement is adapted for use of multiple tenants in system arrangement 1730 (using compute nodes 1737), where containerized pods (e.g., pods 1712), functions (e.g., functions 1713, VNFs 1722, 1736), and functions-as-a-service instances (e.g., FaaS instance 1714) are launched within virtual machines (e.g., VMs 1734, 1735 for tenants 1732, 1733) specific to respective tenants (aside the execution of virtualized network functions). This arrangement is further adapted for use in system arrangement 1740, which provides containers 1742, 1743, or execution of the various functions, applications, and functions on compute nodes 1744, as coordinated by an container-based orchestration system 1741.

The system arrangements of depicted in FIG. 17 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 17, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves, and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

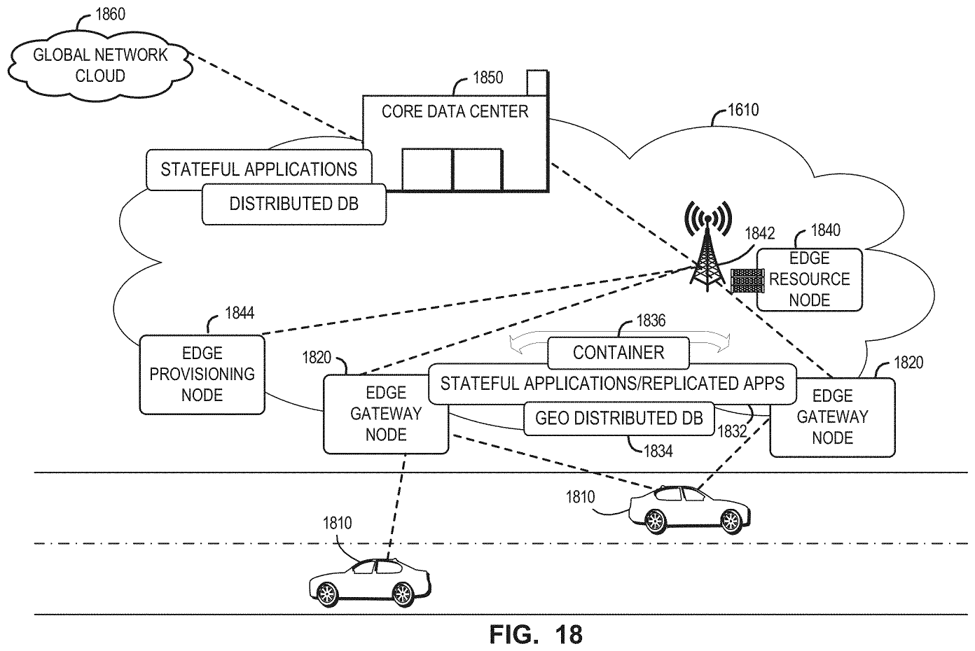

It should be appreciated that the edge computing systems and arrangements discussed herein may be applicable in various solutions, services, and/or use cases involving mobility. As an example, FIG. 18 shows a simplified vehicle compute and communication use case involving mobile access to applications in an edge computing system 1800 that implements an edge cloud 1310. In this use case, respective client compute nodes 1810 may be embodied as in-vehicle compute systems (e.g., in-vehicle navigation and/or infotainment systems) located in corresponding vehicles which communicate with the edge gateway nodes 1820 during traversal of a roadway. For instance, the edge gateway nodes 1820 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 1810 and a particular edge gateway device 1820 may propagate so as to maintain a consistent connection and context for the client compute node 1810. Likewise, mobile edge nodes may aggregate at the high priority services or according to the throughput or latency resolution requirements for the underlying service(s) (e.g., in the case of drones). The respective edge gateway devices 1820 include an amount of processing and storage capabilities and, as such, some processing and/or storage of data for the client compute nodes 1810 may be performed on one or more of the edge gateway devices 1820.

The edge gateway devices 1820 may communicate with one or more edge resource nodes 1840, which are illustratively embodied as compute servers, appliances or components located at or in a communication base station 1842 (e.g., a base station of a cellular network). As discussed above, the respective edge resource nodes 1840 include an amount of processing and storage capabilities and, as such, some processing and/or storage of data for the client compute nodes 1810 may be performed on the edge resource node 1840. For example, the processing of data that is less urgent or important may be performed by the edge resource node 1840, while the processing of data that is of a higher urgency or importance may be performed by the edge gateway devices 1820 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 1840 also communicate with the core data center 1850, which may include compute servers, appliances, and/or other components located in a central location (e.g., a central office of a cellular communication network). The core data center 1850 may provide a gateway to the global network cloud 1860 (e.g., the Internet) for the edge cloud 1610 operations formed by the edge resource node(s) 1840 and the edge gateway devices 1820. Additionally, in some examples, the core data center 1850 may include an amount of processing and storage capabilities and, as such, some processing and/or storage of data for the client compute devices may be performed on the core data center 1850 (e.g., processing of low urgency or importance, or high complexity).

The edge gateway nodes 1820 or the edge resource nodes 1840 may offer the use of stateful applications 1832 and a geographic distributed database 1834. Although the applications 1832 and database 1834 are illustrated as being horizontally distributed at a layer of the edge cloud 1610, it will be understood that resources, services, or other components of the application may be vertically distributed throughout the edge cloud (including, part of the application executed at the client compute node 1810, other parts at the edge gateway nodes 1820 or the edge resource nodes 1840, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 1836 (or pod of containers) may be flexibly migrated from an edge node 1820 to other edge nodes (e.g., 1820, etc.) such that the container with an application and workload does not need to be reconstituted, re-compiled, re-interpreted in order for migration to work. However, in such settings, there may be some remedial or “swizzling” translation operations applied. For example, the physical hardware at node 1840 may differ from edge gateway node 1820 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format or may involve mapping interfaces and operations. A pod controller may be used to drive the interface mapping as part of the container lifecycle, which includes migration to/from different hardware environments.

The scenarios encompassed by FIG. 18 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 1820, some others at the edge resource node 1840, and others in the core data center 1850 or global network cloud 1860.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 1800 can include or be in communication with an edge provisioning node 1844. The edge provisioning node 1844 can distribute software such as the example computer readable instructions 2082 of FIG. 20B, to various receiving parties for implementing any of the methods described herein. The example edge provisioning node 1844 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 1844 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 1844. For example, the entity that owns and/or operates the edge provisioning node 1844 may be a developer, a seller, and/or a licensor (or a customer and/or consumer thereof) of software instructions such as the example computer readable instructions 2082 of FIG. 20B. The receiving parties may be consumers, service providers, users, retailers, OEMs, etc., who purchase and/or license the software instructions for use and/or re-sale and/or sub-licensing.

In an example, edge provisioning node 1844 includes one or more servers and one or more storage devices. The storage devices host computer readable instructions such as the example computer readable instructions 2082 of FIG. 20B, as described below. Similar to the edge gateway devices 1920 described above, the one or more servers of the edge provisioning node 1844 are in communication with a base station 1842 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 2082 from the edge provisioning node 1844. For example, the software instructions, which may correspond to the example computer readable instructions 2082 of FIG. 20B, may be downloaded to the example processor platform/s, which is to execute the computer readable instructions 2082 to implement the methods described herein.

In some examples, the processor platform(s) that execute the computer readable instructions 2082 can be physically located in different geographic locations, legal jurisdictions, etc. In some examples, one or more servers of the edge provisioning node 1844 periodically offer, transmit, and/or force updates to the software instructions (e.g., the example computer readable instructions 2082 of FIG. 20B) to ensure improvements, patches, updates, etc. are distributed and applied to the software instructions implemented at the end user devices. In some examples, different components of the computer readable instructions 2082 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

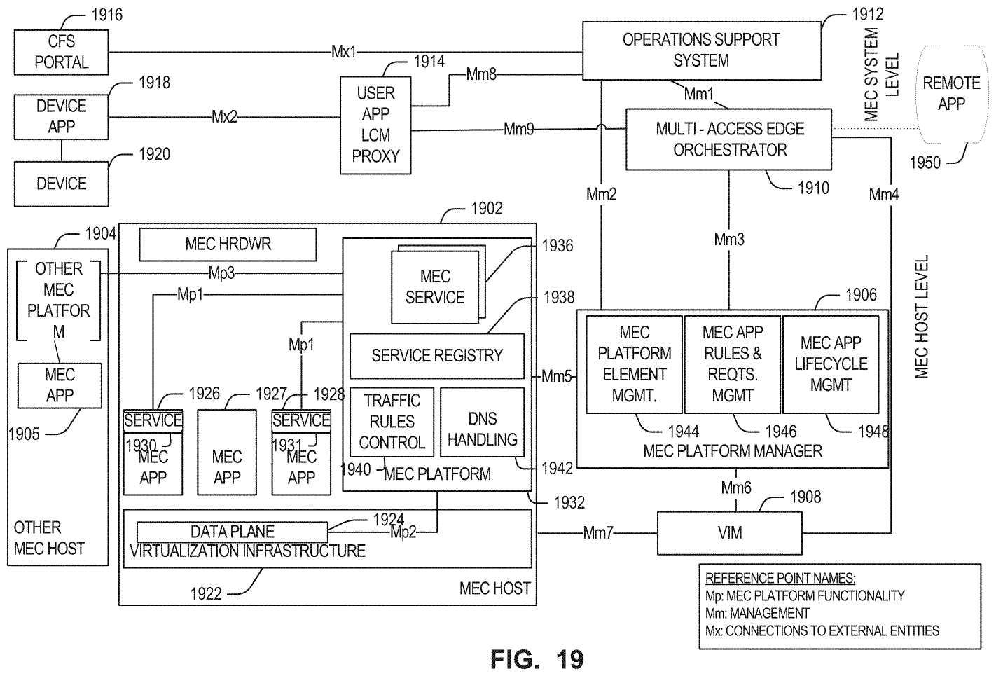

FIG. 19 illustrates a mobile edge system reference architecture (or MEC architecture) 1900, such as is indicated by ETSI MEC specifications. FIG. 19 specifically illustrates a MEC architecture 1900 with MEC hosts 1902 and 1904 providing functionalities in accordance with the ETSI GS MEC-003 specification. In some aspects, enhancements to the MEC platform 1932 and the MEC platform manager 1906 may be used for providing specific computing functions within the MEC architecture 1900.

Referring to FIG. 19, the MEC network architecture 1900 can include MEC hosts 1902 and 1904, a virtualization infrastructure manager (VIM) 1908, an MEC platform manager 1906, an MEC orchestrator 1910, an operations support system 1912, a user app proxy 1914, a UE app 1918 running on UE 1920, and CFS portal 1916. The MEC host 1902 can include a MEC platform 1932 with filtering rules control component 1940, a DNS handling component 1942, a service registry 1938, and MEC services 1936. The MEC services 1936 can include at least one scheduler, which can be used to select resources for instantiating MEC apps (or NFVs) 1926, 1927, and 1928 upon virtualization infrastructure 1922. The MEC apps 1926 and 1928 can be configured to provide services 1930 and 1931, which can include processing network communications traffic of different types associated with one or more wireless connections (e.g., connections to one or more RAN or telecom-core network entities). The MEC app 1905 instantiated within MEC host 1904 can be similar to the MEC apps 1926-1928 instantiated within MEC host 1902. The virtualization infrastructure 1922 includes a data plane 1924 coupled to the MEC platform via an MP2 interface. Additional interfaces between various network entities of the MEC architecture 1900 are illustrated in FIG. 19.

The MEC platform manager 1906 can include MEC platform element management component 1944, MEC app rules and requirements management component 1946, and MEC app lifecycle management component 1948. The various entities within the MEC architecture 1900 can perform functionalities as disclosed by the ETSI GS MEC-003 specification.

In some aspects, the remote application (or app) 1950 is configured to communicate with the MEC host 1902 (e.g., with the MEC apps 1926-1928) via the MEC orchestrator 1910 and the MEC platform manager 1906.

In further examples, any of the compute nodes or devices discussed with reference to the present edge computing systems and environment may be fulfilled based on the components depicted in FIGS. 20A and 20B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 20A, an edge compute node 2000 includes a compute engine (also referred to herein as “compute circuitry”) 2002, an input/output (I/O) subsystem 2008, data storage 2010, a communication circuitry subsystem 2012, and, optionally, one or more peripheral devices 2014. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 2000 may be embodied as any type of engine, device, or collection of devices capable of performing various compute functions. In some examples, the compute node 2000 may be embodied as a single device such as an integrated circuit, an embedded system, a field-programmable gate array (FPGA), a system-on-a-chip (SOC), or other integrated system or device. In the illustrative example, the compute node 2000 includes or is embodied as a processor 2004 and a memory 2006. The processor 2004 may be embodied as any type of processor capable of performing the functions described herein (e.g., executing an application). For example, the processor 2004 may be embodied as a multi-core processor(s), a microcontroller, a processing unit, a specialized or special purpose processing unit, or other processor or processing/controlling circuit.

In some examples, the processor 2004 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 2004 may work in coordination with each other to execute many types of operations and instructions within and on behalf of the compute node 2000.

The memory 2006 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 2006 may be integrated into the processor 2004. The memory 2006 may store various software and data used during operation such as one or more applications, data operated on by the application(s), libraries, and drivers.

The compute circuitry 2002 is communicatively coupled to other components of the compute node 2000 via the I/O subsystem 2008, which may be embodied as circuitry and/or components to facilitate input/output operations with the compute circuitry 2002 (e.g., with the processor 2004 and/or the main memory 2006) and other components of the compute circuitry 2002. For example, the I/O subsystem 2008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2008 may form a portion of a system-on-a-chip (SoC) and be incorporated, along with one or more of the processor 2004, the memory 2006, and other components of the compute circuitry 2002, into the compute circuitry 2002.

The one or more illustrative data storage devices 2010 may be embodied as any type of devices configured for short-term or long-term storage of data such as, for example, memory devices and circuits, memory cards, hard disk drives, solid-state drives, or other data storage devices. Individual data storage devices 2010 may include a system partition that stores data and firmware code for the data storage device 2010. Individual data storage devices 2010 may also include one or more operating system partitions that store data files and executables for operating systems depending on, for example, the type of compute node 2000.

The communication circuitry 2012 may be embodied as any communication circuit, device, or collection thereof, capable of enabling communications over a network between the compute circuitry 2002 and another compute device (e.g., an edge gateway of an implementing edge computing system). The communication circuitry 2012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 2012 includes a network interface controller (NIC) 2020, which may also be referred to as a network interconnect card or a host fabric interface (HFI). The NIC 2020 may be embodied as one or more add-in-boards, daughter cards, network interface cards, controller chips, chipsets, or other devices that may be used by the compute node 2000 to connect with another compute device (e.g., an edge gateway node). In some examples, the NIC 2020 may be embodied as part of a system-on-a-chip (SoC) that includes one or more processors or included on a multichip package that also contains one or more processors. In some examples, the NIC 2020 may include a local processor (not shown) and/or a local memory (not shown) that are both local to the NIC 2020. In such examples, the local processor of the NIC 2020 may be capable of performing one or more of the functions of the compute circuitry 2002 described herein. Additionally, or alternatively, in such examples, the local memory of the NIC 2020 may be integrated into one or more components of the client compute node at the board level, socket level, chip level, and/or other levels.

Additionally, in some examples, a respective compute node 2000 may include one or more peripheral devices 2014. Such peripheral devices 2014 may include any type of peripheral device found in a compute device or server such as audio input devices, a display, other input/output devices, interface devices, and/or other peripheral devices, depending on the particular type of the compute node 2000. In further examples, the compute node 2000 may be embodied by a respective edge compute node (whether a client, gateway, or aggregation node) in an edge computing system or like forms of appliances, computers, subsystems, circuitry, or other components.

In a more detailed example, FIG. 20B illustrates a block diagram of an example of components that may be present in an edge computing node 2050 for implementing the techniques (e.g., operations, processes, methods, and methodologies) described herein. This edge computing node 2050 provides a closer view of the respective components of node 2000 when implemented as or as part of a computing device (e.g., as a mobile device, a base station, server, gateway, etc.). The edge computing node 2050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 2050, or as components otherwise incorporated within a chassis of a larger system.

The edge computing device 2050 may include processing circuitry in the form of a processor 2052, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2052 may be a part of a system on a chip (SoC) in which the processor 2052 and other components are formed into a single integrated circuit, or a single package, such as the Edison™ or Galileo™ SoC boards from Intel Corporation, Santa Clara, Calif. As an example, the processor 2052 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd., or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 2052 and accompanying circuitry may be provided in a single socket form factor, multiple socket form factor, or a variety of other formats, including in limited hardware configurations or configurations that include fewer than all elements shown in FIG. 20B.

The processor 2052 may communicate with a system memory 2054 over an interconnect 2056 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2058 may also couple to the processor 2052 via the interconnect 2056. In an example, the storage 2058 may be implemented via a solid-state disk drive (SSDD). Other devices that may be used for the storage 2058 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 2058 may be on-die memory or registers associated with the processor 2052. However, in some examples, the storage 2058 may be implemented using a micro hard disk drive (HDD). Further, any number of new technologies may be used for the storage 2058 in addition to, or instead of, the technologies described, such resistance change memories, phase change memories, holographic memories, or chemical memories, among others.

The components may communicate over the interconnect 2056. The interconnect 2056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 2056 may couple the processor 2052 to a transceiver 2066, for communications with the connected edge devices 2062. The transceiver 2066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2066 (or multiple transceivers) may communicate using multiple standards or radios for communications at a different range. For example, the edge computing node 2050 may communicate with close devices, e.g., within about 10 meters, using a local transceiver based on Bluetooth Low Energy (BLE), or another low power radio, to save power. More distant connected edge devices 2062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 2066 (e.g., a radio transceiver) may be included to communicate with devices or services in a cloud (e.g., an edge cloud 2095) via local or wide area network protocols. The wireless network transceiver 2066 may be a low-power wide-area (LPWA) transceiver that follows the IEEE 802.15.4, or IEEE 802.15.4g standards, among others. The edge computing node 2050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2066, as described herein. For example, the transceiver 2066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2068 may be included to provide a wired communication to nodes of the edge cloud 2095 or to other devices, such as the connected edge devices 2062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 2068 may be included to enable connecting to a second network, for example, a first NIC 2068 providing communications to the cloud over Ethernet, and a second NIC 2068 providing communications to other devices over another type of network.

Given the variety of types of applicable communications from the device to another component or network, applicable communications circuitry used by the device may include or be embodied by any one or more of components 2064, 2066, 2068, or 2070. Accordingly, in various examples, applicable means for communicating (e.g., receiving, transmitting, etc.) may be embodied by such communications circuitry.

The edge computing node 2050 may include or be coupled to acceleration circuitry 2064, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 2056 may couple the processor 2052 to a sensor hub or external interface 2070 that is used to connect additional devices or subsystems. The devices may include sensors 2072, such as accelerometers, level sensors, flow sensors, optical light sensors, camera sensors, temperature sensors, global navigation system (e.g., GPS) sensors, pressure sensors, barometric pressure sensors, and the like. The hub or interface 2070 further may be used to connect the edge computing node 2050 to actuators 2074, such as power switches, valve actuators, an audible sound generator, a visual warning device, and the like.

In some optional examples, various input/output (I/O) devices may be present within or connected to, the edge computing node 2050. For example, a display or other output device 2084 may be included to show information, such as sensor readings or actuator position. An input device 2086, such as a touch screen or keypad may be included to accept input. An output device 2084 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 2050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2076 may power the edge computing node 2050, although, in examples in which the edge computing node 2050 is mounted in a fixed location, it may have a power supply coupled to an electrical grid, or the battery may be used as a backup or for temporary capabilities. The battery 2076 may be a lithium ion battery, or a metal-air battery, such as a zinc-air battery, an aluminum-air battery, a lithium-air battery, and the like.

A battery monitor/charger 2078 may be included in the edge computing node 2050 to track the state of charge (SoCh) of the battery 2076, if included. The battery monitor/charger 2078 may be used to monitor other parameters of the battery 2076 to provide failure predictions, such as the state of health (SoH) and the state of function (SoF) of the battery 2076. The battery monitor/charger 2078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2078 may communicate the information on the battery 2076 to the processor 2052 over the interconnect 2056. The battery monitor/charger 2078 may also include an analog-to-digital (ADC) converter that enables the processor 2052 to directly monitor the voltage of the battery 2076 or the current flow from the battery 2076. The battery parameters may be used to determine actions that the edge computing node 2050 may perform, such as transmission frequency, mesh network operation, sensing frequency, and the like.

A power block 2080, or other power supply coupled to a grid, may be coupled with the battery monitor/charger 2078 to charge the battery 2076. In some examples, the power block 2080 may be replaced with a wireless power receiver to obtain the power wirelessly, for example, through a loop antenna in the edge computing node 2050. A wireless battery charging circuit, such as an LTC4020 chip from Linear Technologies of Milpitas, Calif., among others, may be included in the battery monitor/charger 2078. The specific charging circuits may be selected based on the size of the battery 2076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2058 may include instructions 2082 in the form of software, firmware, or hardware commands to implement the techniques described herein. Although such instructions 2082 are shown as code blocks included in the memory 2054 and the storage 2058, it may be understood that any of the code blocks may be replaced with hardwired circuits, for example, built into an application specific integrated circuit (ASIC).

In an example, the instructions 2082 provided via the memory 2054, the storage 2058, or the processor 2052 may be embodied as a non-transitory, machine-readable medium 2060 including code to direct the processor 2052 to perform electronic operations in the edge computing node 2050. The processor 2052 may access the non-transitory, machine-readable medium 2060 over the interconnect 2056. For instance, the non-transitory, machine-readable medium 2060 may be embodied by devices described for the storage 2058 or may include specific storage units such as optical disks, flash drives, or any number of other hardware devices. The non-transitory, machine-readable medium 2060 may include instructions to direct the processor 2052 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 2082 on the processor 2052 (separately, or in combination with the instructions 2082 of the machine readable medium 2060) may configure execution or operation of a trusted execution environment (TEE) 2090. In an example, the TEE 2090 operates as a protected area accessible to the processor 2052 for secure execution of instructions and secure access to data. Various implementations of the TEE 2090, and an accompanying secure area in the processor 2052 or the memory 2054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2050 through the TEE 2090 and the processor 2052.

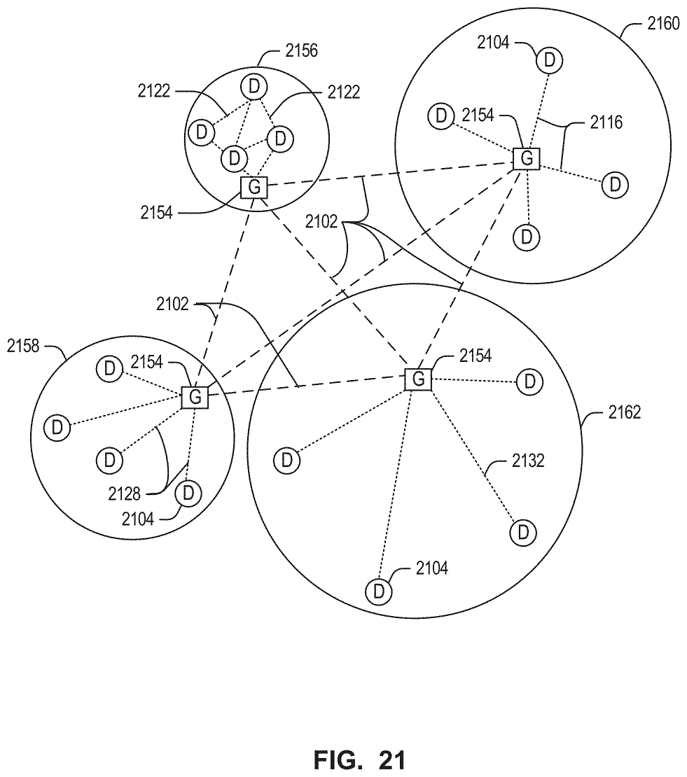

FIG. 21 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

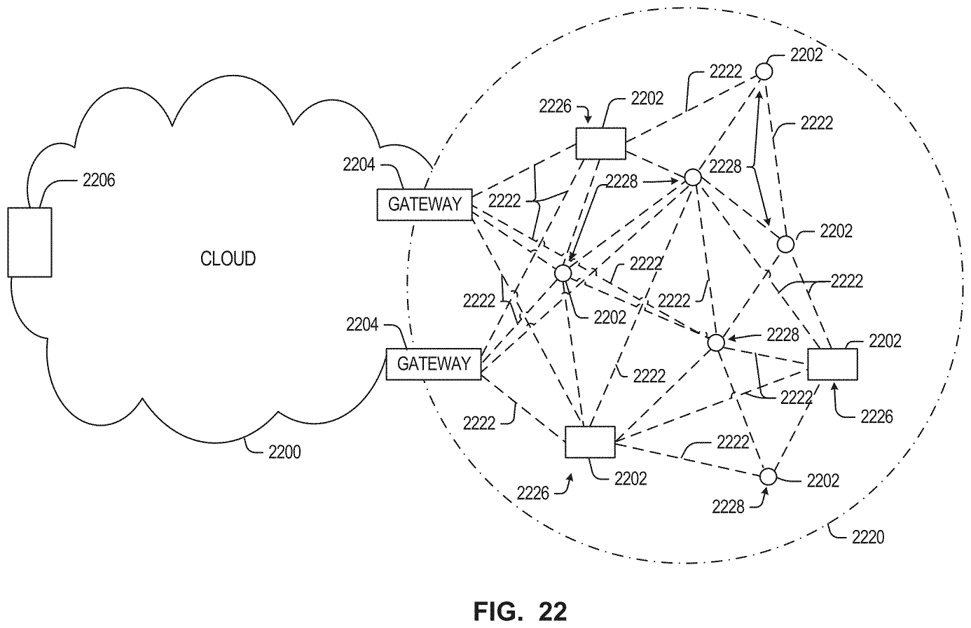

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time, or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 21 and 22, present a number of new challenges in a heterogeneous network of connectivity comprising a combination of wired and wireless technologies.

FIG. 21 specifically provides a simplified drawing of a domain topology that may be used for a number of internet-of-things (IoT) networks comprising IoT devices 2104, with the IoT networks 2156, 2158, 2160, 2162, coupled through backbone links 2102 to respective gateways 2154. For example, a number of IoT devices 2104 may communicate with a gateway 2154, and with each other through the gateway 2154. To simplify the drawing, not every IoT device 2104, or communications link (e.g., link 2116, 2122, 2128, or 2132) is labeled. The backbone links 2102 may include any number of wired or wireless technologies, including optical networks, and may be part of a local area network (LAN), a wide area network (WAN), or the Internet. Additionally, such communication links facilitate optical signal paths among both IoT devices 2104 and gateways 2154, including the use of MUXing/deMUXing components that facilitate interconnection of the various devices.

The network topology may include any number of types of IoT networks, such as a mesh network provided with the network 2156 using Bluetooth low energy (BLE) links 2122. Other types of IoT networks that may be present include a wireless local area network (WLAN) network 2158 used to communicate with IoT devices 2104 through IEEE 802.11 (Wi-Fi®) links 2128, a cellular network 2160 used to communicate with IoT devices 2104 through an LTE/LTE-A (4G) or 5G cellular network, and a low-power wide area (LPWA) network 2162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into “fog” devices or integrated into “edge” computing systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 2104, such as over the backbone links 2102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability, and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QoS) based swarming and fusion of resources. Some of the individual examples of network-based resource processing include the following.

The mesh network 2156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 2158, for instance, may use systems that perform standards conversion to provide multi-standard connectivity, enabling IoT devices 2104 using different protocols to communicate. Further systems may provide seamless interconnectivity across a multi-standard infrastructure comprising visible Internet resources and hidden Internet resources.

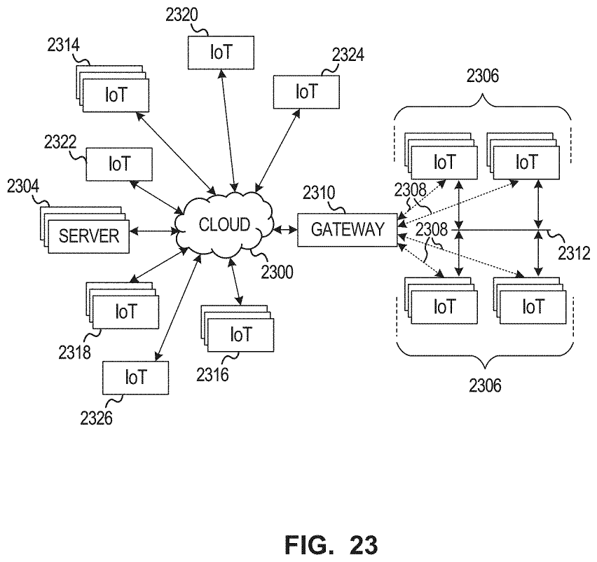

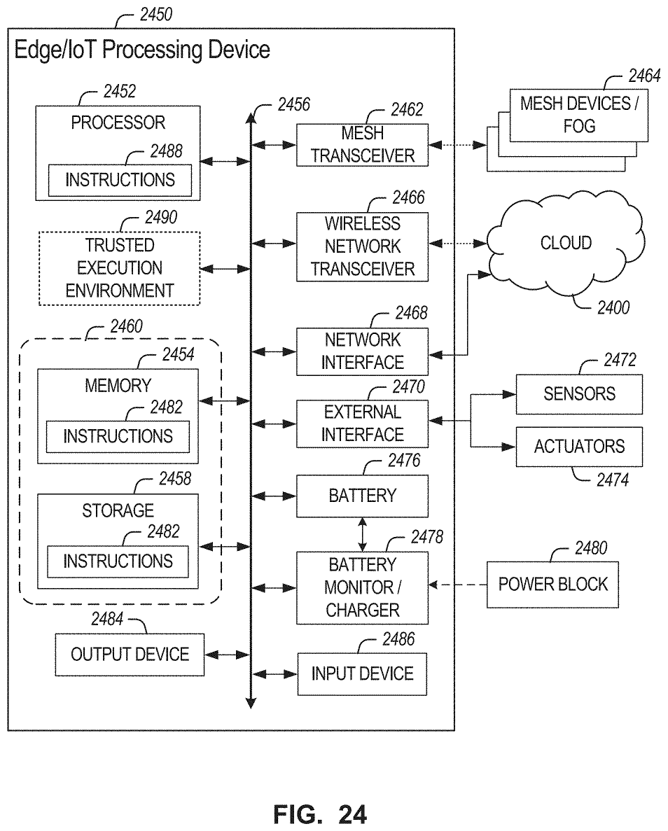

Communications in the cellular network 2160, for instance, may be enhanced by systems that offload data, extend communications to more remote devices, or both. The LPWA network 2162 may include systems that perform non-Internet protocol (IP) to IP interconnections, addressing, and routing. Further, each of the IoT devices 2104 may include the appropriate transceiver for wide area communications with that device. Further, each IoT device 2104 may include other transceivers for communications using additional protocols and frequencies. This is discussed further with respect to the communication environment and hardware of an IoT processing device depicted in FIGS. 23 and 24.

Finally, clusters of IoT devices may be equipped to communicate with other IoT devices as well as with a cloud network. This may allow the IoT devices to form an ad-hoc network between the devices, allowing them to function as a single device, which may be termed a fog device, fog platform, or fog network. This configuration is discussed further with respect to FIG. 22 below.

FIG. 22 illustrates a cloud computing network in communication with a mesh network of IoT devices (devices 2202) operating as a fog platform in a networked scenario. The mesh network of IoT devices may be termed a fog network 2220, established from a network of devices operating at the edge of the cloud 2200. To simplify the diagram, not every IoT device 2202 is labeled.

The fog network 2220 may be considered to be a massively interconnected network wherein a number of IoT devices 2202 are in communications with each other, for example, by radio links 2222. The fog network 2220 may establish a horizontal, physical, or virtual resource platform that can be considered to reside between IoT edge devices and cloud or data centers. A fog network, in some examples, may support vertically-isolated, latency-sensitive applications through layered, federated, or distributed computing, storage, and network connectivity operations. However, a fog network may also be used to distribute resources and services at and among the edge and the cloud. Thus, references in the present document to the “edge”, “fog”, and “cloud” are not necessarily discrete or exclusive of one another.

As an example, the fog network 2220 may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 2202 are shown in this example, gateways 2204, data aggregators 2226, and sensors 2228, although any combinations of IoT devices 2202 and functionality may be used. The gateways 2204 may be edge devices that provide communications between the cloud 2200 and the fog network 2220, and may also provide the backend process function for data obtained from sensors 2228, such as motion data, flow data, temperature data, and the like. The data aggregators 2226 may collect data from any number of the sensors 2228 and perform the back end processing function for the analysis. The results, raw data, or both may be passed along to the cloud 2200 through the gateways 2204. The sensors 2228 may be full IoT devices 2202, for example, capable of both collecting data and processing the data. In some cases, the sensors 2228 may be more limited in functionality, for example, collecting the data and allowing the data aggregators 2226 or gateways 2204 to process the data.

Communications from any IoT device 2202 may be passed along a convenient path between any of the IoT devices 2202 to reach the gateways 2204. In these networks, the number of interconnections provide substantial redundancy, allowing communications to be maintained, even with the loss of a number of IoT devices 2202. Further, the use of a mesh network may allow IoT devices 2202 that are very low power or located at a distance from infrastructure to be used, as the range to connect to another IoT device 2202 may be much less than the range to connect to the gateways 2204.

The fog network 2220 provided from these IoT devices 2202 may be presented to devices in the cloud 2200, such as a server 2206, as a single device located at the edge of the cloud 2200, e.g., a fog network operating as a device or platform. In this example, the alerts coming from the fog platform may be sent without being identified as coming from a specific IoT device 2202 within the fog network 2220. In this fashion, the fog network 2220 may be considered a distributed platform that provides computing and storage resources to perform processing or data-intensive tasks such as data analytics, data aggregation, and machine-learning, among others.

In some examples, the IoT devices 2202 may be configured using an imperative programming style, e.g., with each IoT device 2202 having a specific function and communication partners. However, the IoT devices 2202 forming the fog platform may be configured in a declarative programming style, enabling the IoT devices 2202 to reconfigure their operations and communications, such as to determine needed resources in response to conditions, queries, and device failures. As an example, a query from a user located at a server 2206 about the operations of a subset of equipment monitored by the IoT devices 2202 may result in the fog network 2220 device the IoT devices 2202, such as particular sensors 2228, needed to answer the query. The data from these sensors 2228 may then be aggregated and analyzed by any combination of the sensors 2228, data aggregators 2226, or gateways 2204, before being sent on by the fog network 2220 to the server 2206 to answer the query. In this example, IoT devices 2202 in the fog network 2220 may select the sensors 2228 used based on the query, such as adding data from flow sensors or temperature sensors. Further, if some of the IoT devices 2202 are not operational, other IoT devices 2202 in the fog network 2220 may provide analogous data, if available.

In other examples, the operations and functionality described herein may be embodied by an IoT or edge compute device in the example form of an electronic processing system, within which a set or sequence of instructions may be executed to cause the electronic processing system to perform any one of the methodologies discussed herein, according to an example embodiment. The device may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine.

Further, while only a single machine may be depicted and referenced in the examples above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor, set of processors, or processing circuitry (e.g., a computer) to individually or jointly execute instructions to perform any one or more of the methodologies discussed herein. Accordingly, in various examples, applicable means for processing (e.g., processing, controlling, generating, evaluating, etc.) may be embodied by such processing circuitry.

FIG. 23 illustrates a drawing of a cloud computing network, or cloud 2300, in communication with a number of Internet of Things (IoT) devices. The cloud 2300 may represent the Internet, or may be a local area network (LAN), or a wide area network (WAN), such as a proprietary network for a company. The IoT devices may include any number of different types of devices, grouped in various combinations. For example, a traffic control group 2306 may include IoT devices along streets in a city. These IoT devices may include stoplights, traffic flow monitors, cameras, weather sensors, and the like. The traffic control group 2306, or other subgroups, may be in communication with the cloud 2300 through wired or wireless links 2308, such as LPWA links, and the like. Further, a wired or wireless sub-network 2312 may allow the IoT devices to communicate with each other, such as through a local area network, a wireless local area network, and the like. The IoT devices may use another device, such as a gateway 2310 or 2328 to communicate with remote locations such as the cloud 2300; the IoT devices may also use one or more servers 2330 to facilitate communication with the cloud 2300 or with the gateway 2310. For example, the one or more servers 2330 may operate as an intermediate network node to support a local edge cloud or fog implementation among a local area network. Further, the gateway 2328 that is depicted may operate in a cloud-to-gateway-to-many edge devices configuration, such as with the various IoT devices 2314, 2320, 2324 being constrained or dynamic to an assignment and use of resources in the cloud 2300.

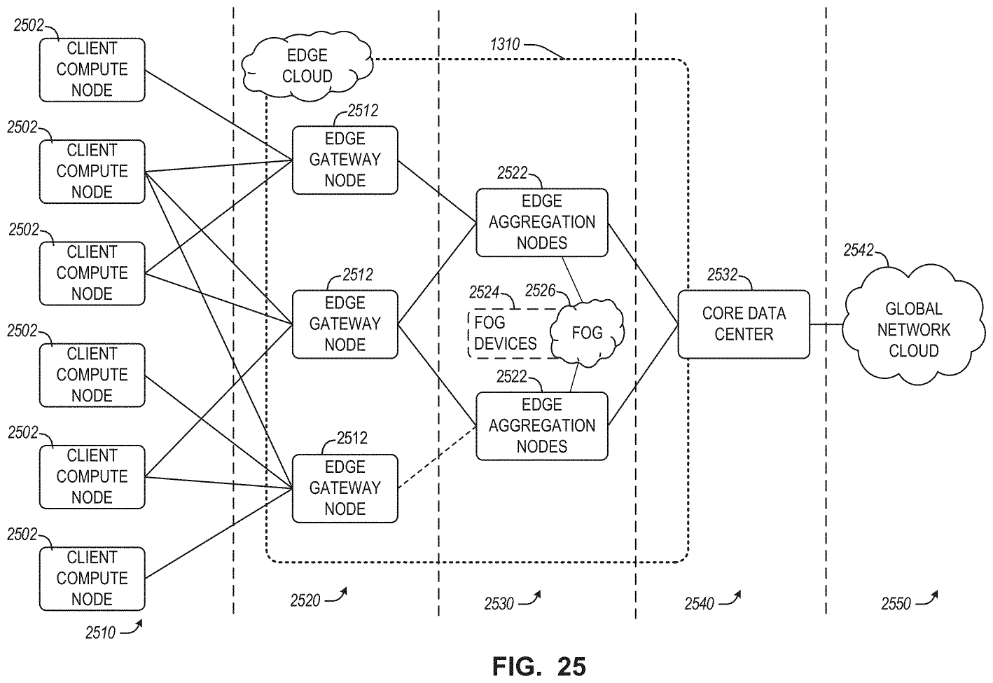

Other example groups of IoT devices may include remote weather stations 2314, local information terminals 2316, alarm systems 2318, automated teller machines 2320, alarm panels 2322, or moving vehicles, such as emergency vehicles 2324 or other vehicles 2326, among many others. Each of these IoT devices may be in communication with other IoT devices, with servers 2304, with another IoT fog device or system (not shown, but depicted in FIG. 25), or a combination therein. The groups of IoT devices may be deployed in various residential, commercial, and industrial settings (including in both private or public environments).

As may be seen from FIG. 23, a large number of IoT devices may be communicating through the cloud 2300. This may allow different IoT devices to request or provide information to other devices autonomously. For example, a group of IoT devices (e.g., the traffic control group 2306) may request a current weather forecast from a group of remote weather stations 2314, which may provide the forecast without human intervention. Further, an emergency vehicle 2324 may be alerted by an automated teller machine 2320 that a burglary is in progress. As the emergency vehicle 2324 proceeds towards the automated teller machine 2320, it may access the traffic control group 2306 to request clearance to the location, for example, by lights turning red to block cross traffic at an intersection in sufficient time for the emergency vehicle 2324 to have unimpeded access to the intersection.

Clusters of IoT devices, such as the remote weather stations 2314 or the traffic control group 2306, may be equipped to communicate with other IoT devices as well as with the cloud 2300. This may allow the IoT devices to form an ad-hoc network between the devices, allowing them to function as a single device, which may be termed a fog device or system (e.g., as described above with reference to FIG. 22).

FIG. 24 is a block diagram of an example of components that may be present in an IoT device 2450 for implementing the techniques described herein. The IoT device 2450 may include any combinations of the components shown in the example or referenced in the disclosure above. The components may be implemented as ICs, portions thereof, discrete electronic devices, or other modules, logic, hardware, software, firmware, or a combination thereof adapted in the IoT device 2450, or as components otherwise incorporated within a chassis of a larger system. Additionally, the block diagram of FIG. 24 is intended to depict a high-level view of components of the IoT device 2450. However, some of the components shown may be omitted, additional components may be present, and different arrangement of the components shown may occur in other implementations.

The IoT device 2450 may include processing circuitry in the form of a processor 2452, which may be a microprocessor, a multi-core processor, a multithreaded processor, an ultra-low voltage processor, an embedded processor, or other known processing elements. The processor 2452 may be a part of a system on a chip (SoC) in which the processor 2452 and other components are formed into a single integrated circuit, or a single package, such as the Edison™ or Galileo™ SoC boards from Intel. As an example, the processor 2452 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd., or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 2452 may communicate with a system memory 2454 over an interconnect 2456 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2458 may also couple to the processor 2452 via the interconnect 2456. In an example the storage 2458 may be implemented via a solid state disk drive (SSDD). Other devices that may be used for the storage 2458 include flash memory cards, such as SD cards, microSD cards, xD picture cards, and the like, and USB flash drives. In low power implementations, the storage 2458 may be on-die memory or registers associated with the processor 2452. However, in some examples, the storage 2458 may be implemented using a micro hard disk drive (HDD). Further, any number of new technologies may be used for the storage 2458 in addition to, or instead of, the technologies described, such resistance change memories, phase change memories, holographic memories, or chemical memories, among others.

The components may communicate over the interconnect 2456. The interconnect 2456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2456 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 2462, 2466, 2468, or 2470. Accordingly, in various examples, applicable means for communicating (e.g., receiving, transmitting, etc.) may be embodied by such communications circuitry.

The interconnect 2456 may couple the processor 2452 to a mesh transceiver 2462, for communications with other mesh devices 2464. The mesh transceiver 2462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 2464. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 2462 may communicate using multiple standards or radios for communications at different range. For example, the IoT device 2450 may communicate with close devices, e.g., within about 10 meters, using a local transceiver based on BLE, or another low power radio, to save power. More distant mesh devices 2464, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 2466 may be included to communicate with devices or services in the cloud 2400 via local or wide area network protocols. The wireless network transceiver 2466 may be a LPWA transceiver that follows the IEEE 802.15.4, or IEEE 802.15.4g standards, among others. The IoT device 2450 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 2462 and wireless network transceiver 2466, as described herein. For example, the radio transceivers 2462 and 2466 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 2462 and 2466 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 2466, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 2468 may be included to provide a wired communication to the cloud 2400 or to other devices, such as the mesh devices 2464. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 2468 may be included to allow connect to a second network, for example, a NIC 2468 providing communications to the cloud over Ethernet, and a second NIC 2468 providing communications to other devices over another type of network.

The interconnect 2456 may couple the processor 2452 to an external interface 2470 that is used to connect external devices or subsystems. The external devices may include sensors 2472, such as accelerometers, level sensors, flow sensors, optical light sensors, camera sensors, temperature sensors, a global positioning system (GPS) sensors, pressure sensors, barometric pressure sensors, and the like. The external interface 2470 further may be used to connect the IoT device 2450 to actuators 2474, such as power switches, valve actuators, an audible sound generator, a visual warning device, and the like.

In some optional examples, various input/output (I/O) devices may be present within, or connected to, the IoT device 2450. For example, a display or other output device 2484 may be included to show information, such as sensor readings or actuator position. An input device 2486, such as a touch screen or keypad may be included to accept input. An output device 2486 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 2450.

A battery 2476 may power the IoT device 2450, although in examples in which the IoT device 2450 is mounted in a fixed location, it may have a power supply coupled to an electrical grid. The battery 2476 may be a lithium ion battery, or a metal-air battery, such as a zinc-air battery, an aluminum-air battery, a lithium-air battery, and the like.

A battery monitor/charger 2478 may be included in the IoT device 2450 to track the state of charge (SoCh) of the battery 2476. The battery monitor/charger 2478 may be used to monitor other parameters of the battery 2476 to provide failure predictions, such as the state of health (SoH) and the state of function (SoF) of the battery 2476. The battery monitor/charger 2478 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 2478 may communicate the information on the battery 2476 to the processor 2452 over the interconnect 2456. The battery monitor/charger 2478 may also include an analog-to-digital (ADC) convertor that allows the processor 2452 to directly monitor the voltage of the battery 2476 or the current flow from the battery 2476. The battery parameters may be used to determine actions that the IoT device 2450 may perform, such as transmission frequency, mesh network operation, sensing frequency, and the like.

A power block 2480, or other power supply coupled to a grid, may be coupled with the battery monitor/charger 2478 to charge the battery 2476. In some examples, the power block 2480 may be replaced with a wireless power receiver to obtain the power wirelessly, for example, through a loop antenna in the IoT device 2450. A wireless battery charging circuit, such as an LTC4020 chip from Linear Technologies of Milpitas, Calif., among others, may be included in the battery monitor/charger 2478. The specific charging circuits chosen depending on the size of the battery 2476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2458 may include instructions 2482 in the form of software, firmware, or hardware commands to implement the techniques described herein. Although such instructions 2482 are shown as code blocks included in the memory 2454 and the storage 2458, it may be understood that any of the code blocks may be replaced with hardwired circuits, for example, built into an application specific integrated circuit (ASIC).

In an example, the instructions 2482 provided via the memory 2454, the storage 2458, or the processor 2452 may be embodied as a non-transitory, machine readable medium 2460 including code to direct the processor 2452 to perform electronic operations in the IoT device 2450. The processor 2452 may access the non-transitory, machine readable medium 2460 over the interconnect 2456. For instance, the non-transitory, machine readable medium 2460 may be embodied by devices described for the storage 2458 of FIG. 24 or may include specific storage units such as optical disks, flash drives, or any number of other hardware devices. The non-transitory, machine readable medium 2460 may include instructions to direct the processor 2452 to perform a specific sequence or flow of actions, for example, as described with respect to the flowchart(s) and block diagram(s) of operations and functionality depicted above.

Also in a specific example, the instructions 2488 on the processor 2452 (separately, or in combination with the instructions 2488 of the machine readable medium 2460) may configure execution or operation of a trusted execution environment (TEE) 2490. In an example, the TEE 2490 operates as a protected area accessible to the processor 2452 for secure execution of instructions and secure access to data. Various implementations of the TEE 2490, and an accompanying secure area in the processor 2452 or the memory 2454 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2450 through the TEE 2490 and the processor 2452.

At a more generic level, an edge computing system may be described to encompass any number of deployments operating in an edge cloud 1310, which provide coordination from client and distributed computing devices. FIG. 25 provides a further abstracted overview of layers of distributed compute deployed among an edge computing environment for purposes of illustration.

FIG. 25 generically depicts an edge computing system for providing edge services and applications to multi-stakeholder entities, as distributed among one or more client compute nodes 2502, one or more edge gateway nodes 2512, one or more edge aggregation nodes 2522, one or more core data centers 2532, and a global network cloud 2542, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 2510, 2520, 2530, 2540, 2550. For example, the client compute nodes 2502 are each located at an endpoint layer 2510, while each of the edge gateway nodes 2512 are located at an edge devices layer 2520 (local level) of the edge computing system. Additionally, each of the edge aggregation nodes 2522 (and/or fog devices 2524, if arranged or operated with or among a fog networking configuration 2526) are located at a network access layer 2530 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 2532 is located at a core network layer 2540 (e.g., a regional or geographically-central level), while the global network cloud 2542 is located at a cloud data center layer 2550 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 2532 may be located within, at, or near the edge cloud 1310.

Although an illustrative number of client compute nodes 2502, edge gateway nodes 2512, edge aggregation nodes 2522, core data centers 2532, global network clouds 2542 are shown in FIG. 25, it should be appreciated that the edge computing system may include more or fewer devices or systems at each layer. Additionally, as shown in FIG. 25, the number of components of each layer 2510, 2520, 2530, 2540, 2550 generally increases at each lower level (i.e., when moving closer to endpoints). As such, one edge gateway node 2512 may service multiple client compute nodes 2502, and one edge aggregation node 2522 may service multiple edge gateway nodes 2512.

Consistent with the examples provided herein, each client compute node 2502 may be embodied as any type of end point component, device, appliance, or “thing” capable of communicating as a producer or consumer of data. Further, the label “node” or “device” as used in the edge computing system 2500 does not necessarily mean that such node or device operates in a client or agent/minion/follower role; rather, any of the nodes or devices in the edge computing system 2500 refer to individual entities, nodes, or subsystems which include discrete or connected hardware or software configurations to facilitate or use the edge cloud 1310.

As such, the edge cloud 1310 is formed from network components and functional features operated by and within the edge gateway nodes 2512 and the edge aggregation nodes 2522 of layers 2520, 2530, respectively. The edge cloud 1310 may be embodied as any type of network that provides edge computing and/or storage resources which are proximately located to radio access network (RAN) capable endpoint devices (e.g., mobile computing devices, IoT devices, smart devices, etc.), which are shown in FIG. 25 as the client compute nodes 2502. In other words, the edge cloud 1310 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 1310 may form a portion of or otherwise provide an ingress point into or across a fog networking configuration 2526 (e.g., a network of fog devices 2524, not shown in detail), which may be embodied as a system-level horizontal and distributed architecture that distributes resources and services to perform a specific function. For instance, a coordinated and distributed network of fog devices 2524 may perform computing, storage, control, or networking aspects in the context of an IoT system arrangement. Other networked, aggregated, and distributed functions may exist in the edge cloud 1310 between the cloud data center layer 2550 and the client endpoints (e.g., client compute nodes 2502). Some of these are discussed in the following sections in the context of network functions or service virtualization, including the use of virtual edges and virtual services which are orchestrated for multiple stakeholders.

The edge gateway nodes 2512 and the edge aggregation nodes 2522 cooperate to provide various edge services and security to the client compute nodes 2502. Furthermore, because each client compute node 2502 may be stationary or mobile, each edge gateway node 2512 may cooperate with other edge gateway devices to propagate presently provided edge services and security as the corresponding client compute node 2502 moves about a region. To do so, each of the edge gateway nodes 2512 and/or edge aggregation nodes 2522 may support multiple tenancy and multiple stakeholder configurations, in which services from (or hosted for) multiple service providers and multiple consumers may be supported and coordinated across a single or multiple compute devices.

From the foregoing, it will be appreciated that example methods, apparatus, systems, and articles of manufacture have been disclosed that enable identification, organization, management, querying, and deployment of AI-NF and/or other AI models via an edge computing infrastructure. As such, the disclosed methods, apparatus, systems, and articles of manufacture improve the security, attestability, reliability, and effectiveness of using a computing device in an edge computing infrastructure to leverage the best models available from different sources in different domains, connected via the edge computing infrastructure. Cross-domain interaction is achieved while safeguarding the integrity of the source device. Disclosed methods, apparatus and articles of manufacture are accordingly directed to one or more improvement(s) in the functioning of a computer or computing device/circuitry.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Further aspects of the present disclosure are provided by the subject matter of the following clauses:

Example 1 is an edge infrastructure apparatus including: a model data structure to identify a plurality of models and associated meta-data from a plurality of circuitry connectable via the edge infrastructure apparatus; model inventory circuitry to manage the model data structure to at least one of query for one or more models, add a model, update a model, or remove a model from the model data structure; model discovery circuitry to select a selected model of the plurality of models identified in the model data structure in response to a query; and execution logic circuitry to inference the selected model.

Example 2 includes the apparatus of example 1, further including an interface to receive a request and to output at least one of an instance of the selected model or an outcome of the inference of the selected model.

Example 3 includes the apparatus of example 1, further including a training entity to train a query model to query the model data structure and evaluate the at least one selected model.

Example 4 includes the apparatus of example 1, further including a model cache to store an instance of at least a subset of the plurality of models identified in the model data structure.

Example 5 includes the apparatus of example 1, further include telemetry circuitry to provide at least one of network telemetry or edge appliance telemetry information for selection of the at least one selected model.

Example 6 includes the apparatus of example 1, wherein the model data structure is a table stored in memory identifying the plurality of models by: a) at least one of name or identifier, b) source, and c) meta-data.

Example 7 includes the apparatus of example 6, wherein the meta-data includes at least one of an accuracy, a recall, or a latency associated with the respective model.

Example 8 includes the apparatus of example 6, wherein the model discovery circuitry is to compare at least two of the plurality of models based on their associated meta-data.

Example 9 includes the apparatus of example 1, wherein the plurality of models includes artificial intelligence named function models.

Example 10 includes the apparatus of example 1, wherein an output of the inference of the selected model is a score.

Example 11 includes the apparatus of example 1, wherein the execution logic circuitry is to output a prediction based on the selected model.

Example 12 is at least one non-transitory computer readable storage medium including instructions that, when executed, cause at least one processor to at least: manage a model data structure, the model data structure identifying a plurality of models and associated meta-data from a plurality of circuitry connectable via an edge infrastructure apparatus; process a query to at least one of identify a model, add a model, update a model, or remove a model from the model data structure; select a selected model of the plurality of models identified in the model data structure in response to a query; and output at least one of an instance of the selected model or an inference of the selected model.

Example 13 includes the at least one non-transitory computer readable storage medium of example 12, wherein the instructions, when executed, cause the at least one processor to receive, via an interface, a request and to output, via the interface, at least one of an instance of the selected model or an outcome of the inference of the selected model.

Example 14 includes the at least one non-transitory computer readable storage medium of example 12, wherein the instructions, when executed, cause the at least one processor to store an instance of at least a subset of the plurality of models identified in the model data structure in a cache.

Example 15 includes the at least one non-transitory computer readable storage medium of example 12, wherein the model data structure is a table stored in memory identifying the plurality of models by: a) at least one of name or identifier, b) source, and c) meta-data, wherein the meta-data includes at least one of an accuracy, a recall, or a latency associated with the respective model, and wherein the instructions, when executed, cause the at least one processor to compare at least two of the plurality of models based on their associated meta-data.

Example 16 is a method including: managing, by executing an instruction using at least one processor, a model data structure, the model data structure identifying a plurality of models and associated meta-data from a plurality of circuitry connectable via an edge infrastructure apparatus; processing, by executing an instruction using the at least one processor, a query to at least one of identify a model, add a model, update a model, or remove a model from the model data structure; selecting, by executing an instruction using the at least one processor, a selected model of the plurality of models identified in the model data structure in response to a query; and outputting, by executing an instruction using the at least one processor, at least one of an instance of the selected model or an inference of the selected model.

Example 17 includes the method of example 16, further including receiving a request and outputting at least one of an instance of the selected model or an outcome of the inference of the selected model.

Example 18 includes the method of example 16, further including storing an instance of at least a subset of the plurality of models identified in the model data structure in a cache.

Example 19 includes the method of example 16, wherein the model data structure is a table stored in memory identifying the plurality of models by: a) at least one of name or identifier, b) source, and c) meta-data, wherein the meta-data includes at least one of an accuracy, a recall, or a latency associated with the respective model, and wherein the method further includes comparing at least two of the plurality of models based on their associated meta-data.

Example 20 is an apparatus including: memory circuitry to include instructions; and at least one processor to execute the instructions to at least: manage a model data structure, the model data structure identifying a plurality of models and associated meta-data from a plurality of circuitry connectable via an edge infrastructure apparatus; process a query to at least one of identify a model, add a model, update a model, or remove a model from the model data structure; select a selected model of the plurality of models identified in the model data structure in response to a query; and output at least one of an instance of the selected model or an inference of the selected model.

Example 21 is an edge server apparatus including: local inventory circuitry to identify at least one artificial intelligence model and associated meta-data; and logic circuitry to process a request to query for a first model, the logic circuitry to query the local inventory circuitry and to query edge infrastructure circuitry for the first model, the logic circuitry to select the first model from a plurality of results.

Example 22 includes the apparatus of example 21, wherein the query is based on at least one of a named function, an identifier, or meta-data associated with the first model.

Example 23 includes the apparatus of example 22, wherein the meta-data includes at least one of an accuracy, a recall, or a latency for the first model.

Example 24 is an apparatus including: means for managing a model data structure, the model data structure identifying a plurality of models and associated meta-data from a plurality of circuitry connectable via an edge infrastructure apparatus; means for processing a query to at least one of identify a model, add a model, update a model, or remove a model from the model data structure; select a selected model of the plurality of models identified in the model data structure in response to a query; and means for outputting at least one of an instance of the selected model or an inference of the selected model.

Example 25 is an apparatus including: means for identifying at least one artificial intelligence model and associated meta-data; and means for processing a request to query for a first model, means for processing to query for the first model and to select the first model from a plurality of results.

Example 26 includes any of examples 1-25, wherein the model data structure includes a distributed ledger.

Example 27 includes example 26, wherein the distributed ledger includes a blockchain.

Example 28 includes any of examples 1-27 implemented in an edge cloud infrastructure.

Example 29 includes any of examples 1-28 implemented with a vehicle-to-everything network.

Example 30 includes any of examples 1-20. wherein the model is a proprietary model.

Example 31 includes any of examples 1-30, wherein the model is a hybrid model including a general portion and a proprietary portion.

The following claims are hereby incorporated into this Detailed Description by this reference, with each claim standing on its own as a separate embodiment of the present disclosure.

What is claimed is:

1. An edge infrastructure apparatus comprising:
a model data structure to identify a plurality of models and associated meta-data from a plurality of circuitry connectable via the edge infrastructure apparatus;
model inventory circuitry to manage the model data structure to at least one of query for one or more models, add a model, update a model, or remove a model from the model data structure;
model discovery circuitry to select a selected model of the plurality of models identified in the model data structure in response to a query; and
execution logic circuitry to inference the selected model.

2. The apparatus of claim 1, further including an interface to receive a request and to output at least one of an instance of the selected model or an outcome of the inference of the selected model.

3. The apparatus of claim 1, further including a training entity to train a query model to query the model data structure and evaluate the at least one selected model.

4. The apparatus of claim 1, further including a model cache to store an instance of at least a subset of the plurality of models identified in the model data structure.

5. The apparatus of claim 1, further include telemetry circuitry to provide at least one of network telemetry or edge appliance telemetry information for selection of the at least one selected model.

6. The apparatus of claim 1, wherein the model data structure is a table stored in memory identifying the plurality of models by: a) at least one of name or identifier, b) source, and c) meta-data.

7. The apparatus of claim 6, wherein the meta-data includes at least one of an accuracy, a recall, or a latency associated with the respective model.

8. The apparatus of claim 6, wherein the model discovery circuitry is to compare at least two of the plurality of models based on their associated meta-data.

9. The apparatus of claim 1, wherein the plurality of models includes artificial intelligence named function models.

10. The apparatus of claim 1, wherein an output of the inference of the selected model is a score.

11. The apparatus of claim 1, wherein the execution logic circuitry is to output a prediction based on the selected model.

12. At least one non-transitory computer readable storage medium comprising instructions that, when executed, cause at least one processor to at least:
manage a model data structure, the model data structure identifying a plurality of models and associated meta-data from a plurality of circuitry connectable via an edge infrastructure apparatus;
process a query to at least one of identify a model, add a model, update a model, or remove a model from the model data structure;
select a selected model of the plurality of models identified in the model data structure in response to a query; and
output at least one of an instance of the selected model or an inference of the selected model.

13. The at least one non-transitory computer readable storage medium of claim 12, wherein the instructions, when executed, cause the at least one processor to receive, via an interface, a request and to output, via the interface, at least one of an instance of the selected model or an outcome of the inference of the selected model.

14. The at least one non-transitory computer readable storage medium of claim 12, wherein the instructions, when executed, cause the at least one processor to store an instance of at least a subset of the plurality of models identified in the model data structure in a cache.

15. The at least one non-transitory computer readable storage medium of claim 12, wherein the model data structure is a table stored in memory identifying the plurality of models by: a) at least one of name or identifier, b) source, and c) meta-data, wherein the meta-data includes at least one of an accuracy, a recall, or a latency associated with the respective model, and wherein the instructions, when executed, cause the at least one processor to compare at least two of the plurality of models based on their associated meta-data.

16. A method comprising:
managing, by executing an instruction using at least one processor, a model data structure, the model data structure identifying a plurality of models and associated meta-data from a plurality of circuitry connectable via an edge infrastructure apparatus;
processing, by executing an instruction using the at least one processor, a query to at least one of identify a model, add a model, update a model, or remove a model from the model data structure;
selecting, by executing an instruction using the at least one processor, a selected model of the plurality of models identified in the model data structure in response to a query; and
outputting, by executing an instruction using the at least one processor, at least one of an instance of the selected model or an inference of the selected model.

17. The method of claim 16, further including receiving a request and outputting at least one of an instance of the selected model or an outcome of the inference of the selected model.

18. The method of claim 16, further including storing an instance of at least a subset of the plurality of models identified in the model data structure in a cache.

19. The method of claim 16, wherein the model data structure is a table stored in memory identifying the plurality of models by: a) at least one of name or identifier, b) source, and c) meta-data, wherein the meta-data includes at least one of an accuracy, a recall, or a latency associated with the respective model, and wherein the method further includes comparing at least two of the plurality of models based on their associated meta-data.

20. An apparatus comprising:
memory circuitry to include instructions; and
at least one processor to execute the instructions to at least:
manage a model data structure, the model data structure identifying a plurality of models and associated meta-data from a plurality of circuitry connectable via an edge infrastructure apparatus;
process a query to at least one of identify a model, add a model, update a model, or remove a model from the model data structure;
select a selected model of the plurality of models identified in the model data structure in response to a query; and
output at least one of an instance of the selected model or an inference of the selected model.

21. An edge server apparatus comprising:
local inventory circuitry to identify at least one artificial intelligence model and associated meta-data; and
logic circuitry to process a request to query for a first model,
the logic circuitry to query the local inventory circuitry and to query edge infrastructure circuitry for the first model, the logic circuitry to select the first model from a plurality of results.

22. The apparatus of claim 21, wherein the query is based on at least one of a named function, an identifier, or meta-data associated with the first model.

23. The apparatus of claim 22, wherein the meta-data includes at least one of an accuracy, a recall, or a latency for the first model.

24. The apparatus of claim 21, wherein the first model is a proprietary model.

25. The apparatus of claim 21, wherein the first model is a hybrid model including a general portion and a proprietary portion.
